(19) United States
(12) Patent Application Publication
(10) Pub. No.: US 2025/0001342 A1
(43) Pub. Date: Jan. 2, 2025

(54) FILTER-HOUSING INTERFACE DESIGNS FOR HEATING, VENTILATION, AND AIR CONDITIONING SYSTEMS

(71) Applicant: Research Products Corporation, Madison, WI (US)

(72) Inventors: Peter J. Davis, Madison, WI (US); Thomas J. Anoszko, Madison, WI (US); Steven J. Buth, Madison, WI (US); John R. Genova, Madison, WI (US); Yiwu Yu, Madison, WI (US)

(73) Assignee: Research Products Corporation, Madison, WI (US)

(21) Appl. No.: 18/758,146

(22) Filed: Jun. 28, 2024

Related U.S. Application Data
(60) Provisional application No. 63/524,029, filed on Jun. 29, 2023.

(51) Int. Cl. B01D 46/00; B01D 46/52; F24F 8/108

(52) U.S. Cl. CPC B01D 46/0006; B01D 46/521; F24F 8/108; B01D 2265/023; B01D 2265/025; B01D 2265/028; B01D 2273/14; B01D 2279/50

(57) ABSTRACT

A filter element for a heating, ventilation, and/or air conditioning (HVAC) system includes a filter media pack, a support element, and a magnetic material. The support element is configured to couple the filter media pack to a filter housing. The support element extends along a longitudinal direction from a first longitudinal end to a second longitudinal end. The magnetic material is disposed on the first longitudinal end of the support element. The magnetic material is configured to magnetically engage a second magnetic material of the filter housing to facilitate alignment between the a housing rail of the filter housing and the support element during installation of the support element into a filter housing.

### CROSS-REFERENCE TO RELATED PATENT APPLICATIONS

This application claims the benefit of and priority to U.S. Provisional Patent Application No. 63/524,029, filed Jun. 29, 2023, the entire contents of which are hereby incorporated by reference herein.

### BACKGROUND

The present disclosure relates generally air filtration systems for removing particulate matter and other contaminants from air. More specifically, the present disclosure relates to filter-housing interface designs used to secure the filter element within a housing of an air filtration system.

### SUMMARY

One embodiment relates to a filter element for a heating, ventilation, and/or air conditioning system. The filter element includes a filter media pack, a support element, and a magnetic material. The support element is configured to couple the filter media pack to a filter housing. The support element extends along a longitudinal direction from a first longitudinal end to a second longitudinal end. The magnetic material is disposed on the first longitudinal end of the support element. The magnetic material is configured to magnetically engage a second magnetic material of the filter housing to facilitate alignment between the a housing rail of the filter housing and the support element during installation of the support element into a filter housing.

Another embodiment relates to a support element for a filter element for a heating, ventilation, and/or air conditioning system. The support element includes a first interface member, a second interface member, a connecting member, and a magnetic material. The first interface member extends along a longitudinal direction. The second interface member is spaced apart from the first interface member and extends parallel to the first interface member. The connecting member is configured to couple the first interface member and the second interface member to a filter media pack. The connecting member extends from the first interface member to the second interface member. The magnetic material is disposed on a first longitudinal end of at least one of the connecting member, the first interface member, or the second interface member.

Yet another embodiment relates to a filter element for a heating, ventilation, and/or air conditioning system. The filter element includes a filter media pack, a first support element, and a second support element. The first support element is coupled to the filter media pack. The second support element is coupled to an opposing end of the filter media pack as the first support element. The filter media pack is reconfigurable between a collapsed position in which the first support element and the second support element are separated by a first distance along an expansion direction of the filter media pack, and an expanded position in which the first support element and the second support element are separated by a second distance along the expansion direction that is greater than the first distance. The first support element includes a snap-fit interface that is configured to couple the support element to a housing rail.

Yet another embodiment relates to a filter housing for a heating, ventilation, and air conditioning system. The filter housing includes a frame, a plurality of sidewalls, and an adjustable flange. The sidewalls are coupled to the frame and enclose at least three sides of the frame. The sidewalls and the frame together define an interior cavity, a duct opening, and an access opening. The interior cavity is configured to receive a filter element therein. The duct opening is disposed at a first lateral end of the interior cavity. The access opening is disposed at a longitudinal end of the interior cavity. The adjustable flange extends across the duct opening between opposing ends of the duct opening. The adjustable flange is movably coupled the frame and/or the plurality of sidewalls and is movable between a first position covering a first portion of the duct opening, and a second position covering the first portion and a second portion of the duct opening that is greater than the first area.

In some embodiments, the filter housing further includes a second adjustable flange extending across the duct opening, the second adjustable flange extending perpendicular to the first adjustable flange. In such implementations, the first adjustable flange may engage the second adjustable flange proximate a corner region of the duct opening.

In some embodiments, the filter housing further includes a seal member coupled to at least one of the frame or the plurality of sidewalls. In such implementations, the seal member may extend along an entire perimeter of the duct opening and facing a flow direction through the duct opening.

Another embodiment relates a filter housing for a heating, ventilation, and air conditioning system. The filter housing includes a frame, a plurality of sidewalls, and a plurality of mounting elements. The sidewalls are coupled to the frame and enclose at least three sides of the frame. The sidewalls and the frame together define an interior cavity configured to receive a filter element therein, a first opening at a first lateral end of the interior cavity, a second opening at a second lateral end of the interior cavity opposite the first lateral end, and an access opening disposed at a longitudinal end of the interior cavity between the first opening and the second opening. The mounting elements are coupled to at least one of the frame and/or the plurality of sidewalls at the first opening. The mounting elements extend inwardly into the first opening from an outer perimeter of the first opening. The mounting elements are configured to couple the filter housing to a furnace or a ductwork.

In some embodiments, the plurality of mounting elements includes a plurality of bendable tabs that are integrally formed with at least one of the plurality of sidewalls from a single piece of material. In such implementations, the bendable tabs may be configured to bend at a bend line disposed at the outer perimeter of the first opening.

In some embodiments, the plurality of mounting elements includes a plurality of clips that are configured to couple the filter housing to a furnace or a ductwork. In such embodiments, the plurality of clips may include a base tab, a first fastener tab, and a second fastener tab. In some embodiments, the first fastener tab and the second fastener tab both extend substantially parallel to the base tab and offset from the base tab. In some embodiments, the second fastener tab is offset from the first fastener tab.

In some embodiments, the plurality of mounting elements includes a first attachment rail disposed on a first end of the enclosure and a second attachment rail disposed on a second end of the enclosure. In such embodiments, the enclosure may be slidably engaged with the first attachment rail and the second attachment rail.

In some embodiments, at least one of the plurality of sidewalls defines a slot adjoining the access opening. In some embodiments, the housing further includes a cover that is coupled to the enclosure at the access opening so that a portion of the cover is disposed within the slot.

Yet another embodiment relates to a filter housing for a heating, ventilation, and air conditioning system. The filter housing includes a frame, a plurality of sidewalls, and a cover. The sidewalls are coupled to the frame and enclose at least three sides of the frame to form an enclosure. The sidewalls and the frame together define an interior cavity configured to receive a filter element therein, a first opening at a first lateral end of the interior cavity, a second opening at a second lateral end of the interior cavity opposite the first lateral end, an access opening disposed at a longitudinal end of the interior cavity between the first opening and the second opening, and a slot adjoining the access opening. The cover is coupled to the enclosure at the access opening. At least a portion of the cover is disposed within the slot.

In some embodiments, the cover is pivotally coupled to a first end of the access opening. In some embodiments, the cover is detachably coupled to the enclosure at a second end that opposes the first end.

In some embodiments, the cover is part of a cover assembly and defines a plurality of pockets. In some embodiments, the cover assembly further includes a plurality of magnets disposed within the plurality of pockets.

In some embodiments, the cover is part of a cover assembly that includes at least one magnet coupled to the cover, and a latch coupled to the cover and disposed proximate to the at least one magnet.

In some embodiments, the filter housing further includes a spring-loaded clip coupled to the enclosure proximate to the access opening. In some embodiments, the cover defines a slot configured to engage with the spring loaded clip when the cover is installed onto the enclosure.

In some embodiments, the cover defines a channel that is configured to receive a filter media end therein. In some embodiments, the cover is configured to directly couple to an end of the filter element. In some embodiments, the cover is part of a cover assembly that further includes a filter change indicator dial coupled to the cover. The filter change indicator dial may be configured to indicate a next service interval for the filter element.

Yet another embodiment relates to a filter assembly including a filter housing, a rail member, and a filter element. The filter housing defines an interior cavity, a first opening at a first lateral end of the interior cavity, a second opening at a second lateral end of the interior cavity opposite the first lateral end, and an access opening at a longitudinal end of the interior cavity between the first opening and the second opening. The rail member is disposed within the interior cavity. The filter element includes a filter media pack and a frame element coupled to an end of the filter media pack. The frame element includes a clip member that is configured to clip onto the rail member so as to slidably engage the frame element to the rail member.

In some embodiments, the clip member includes a first clip member portion and a second clip member portion arranged parallel to and offset from the first clip member portion. In some embodiments, the first clip member portion and the second clip member portion together define a channel.

In some embodiments, the filter assembly may further include a snap clip coupled to the rail member and configured to provide an audible indication to a user when the filter element is fully installed into the filter housing. In such embodiments, the frame member may define a notch, and the snap clip may be configured to engage the notch when the filter element is fully installed into the filter housing.

In some embodiments, the rail member extends in the longitudinal direction along the enclosure. In some embodiments, the rail member including an end portion that curves along a flow direction through the filter housing. In some embodiments, the frame member is configured to magnetically couple to the rail member.

Yet another embodiment relates to a filter assembly that includes a filter housing, a rail member, and a filter element. The filter housing defines an interior cavity, a first opening at a first lateral end of the interior cavity, a second opening at a second lateral end of the interior cavity opposite the first lateral end, and an access opening at a longitudinal end of the interior cavity between the first opening and the second opening. The rail member is disposed within the interior cavity. The rail member defines a first channel. The filter element includes a filter media pack and a frame element. The frame element includes a panel that is coupled to the filter media pack and an attachment member. The attachment member is arranged parallel to and offset from the panel. The attachment member is disposed at a central position along the panel and engages the first channel to couple the filter element to the filter housing.

In some embodiments, a width of the attachment member is less than a width of the panel. In some embodiments, the frame member further includes an extension coupled to the attachment member and the panel. The attachment member and the extension may be integrally formed with the panel from a single piece of material. In such embodiments, the attachment member and the extension may together define a ‘T’ shape when viewed along a cross-section through the longitudinal end of the panel.

In some embodiments, the rail member is integrally formed with the filter housing. In some embodiments, at least one of the rail member or the attachment member includes a rounded or chamfered lead-in. In some embodiments, the rail member further defines a second channel on an opposing end of the rail member as the first channel.

Yet another embodiment relates to a filter assembly including a filter housing and a cover assembly. The filter housing defines an interior cavity, a first opening at a first lateral end of the interior cavity, a second opening at a second lateral end of the interior cavity opposite the first lateral end, and an access opening at a longitudinal end of the interior cavity between the first opening and the second opening. The cover assembly is coupled to the enclosure at the access opening. The cover assembly includes a cover base and at least one shaft. The cover base extends across the access opening. The at least one shaft extends away from the cover base and into the interior cavity. The at least one shaft engages the filter housing at an opposite end of the housing as the cover base.

In some embodiments, the filter assembly further includes a filter media pack coupled to the at least one shaft. In some embodiments, the filter assembly further includes a filter media pack that includes at least one loop. In such embodiments, the at least one shaft may be inserted into the at least one loop. In some embodiments, the cover assembly further comprises a clip that is coupled to the cover base and that engages the at least one shaft. In such embodiments, the filter assembly further may further include a filter media pack that is coupled to the shaft by the clip.

### BRIEF DESCRIPTION OF THE FIGURES

FIG. 1 is a side view of a heating, ventilation, and air conditioning system for a building, according to an embodiment.

FIG. 2 is a perspective view of a filter housing assembly that includes an adjustable flange at an opening of the filter housing assembly, according to an embodiment.

FIG. 3 is a side view of the filter housing assembly of FIG. 2.

FIG. 4 is a perspective view of a filter housing assembly that includes an adjustable flange at an opening of the filter housing assembly, according to another embodiment.

FIG. 5 is a perspective view of a filter housing assembly that includes an adjustable flange at an opening of the filter housing assembly adjacent to an access opening of the filter housing assembly, according to another embodiment.

FIG. 6 is a perspective view of a filter housing assembly that includes an adjustable flange extending across an upper end of an opening of the filter housing assembly, according to an embodiment.

FIG. 7 is a perspective view of a filter housing assembly that includes a plurality of adjustable flanges at an opening of the filter housing assembly, according to an embodiment.

FIG. 8 is a perspective view of a filter housing assembly including at least one seal member, according to an embodiment.

FIG. 9 is a side view of the filter housing assembly of FIG. 8.

FIG. 10 is a perspective view of a filter housing assembly including a plurality of mounting elements at an opening of the filter housing assembly, according to an embodiment.

FIG. 11 is a perspective view of an individual mounting element from the filter housing assembly of FIG. 10.

FIG. 12 is a side view of the filter housing assembly of FIG. 10.

FIG. 13 is a perspective view of a heating, ventilation, and air conditioning (HVAC) system that includes a filter housing assembly having mounting clips, according to an embodiment.

FIG. 14 is an exploded perspective view of the HVAC system of FIG. 13.

FIG. 15 is a perspective view of an HVAC system that includes an air filter assembly having mounting clips, according to another embodiment.

FIG. 16 is a perspective view of a mounting clip of the filter assembly of FIG. 15.

FIG. 17 is a side cross-sectional view of a mounting interface between the air filter assembly of FIG. 15 and a furnace.

FIG. 18 is a perspective view of the furnace of FIG. 17 in isolation from the air filter assembly.

FIG. 19 is a perspective view of a filter housing assembly including a pair of attachment rails, according to an embodiment.

FIG. 20 is a perspective view of a portion of an air filter housing that includes a notch adjacent to an access opening of the air filter housing, according to an embodiment.

FIG. 21 is a perspective view of the air filter housing of FIG. 20 with a cover attached thereto.

FIG. 22 is a perspective view of a portion of an air filter assembly with a removable cover, according to an embodiment.

FIG. 23 is a perspective view of the air filter assembly of FIG. 22 showing interior facing edges of a cover assembly of the air filter assembly.

FIG. 24 is a front perspective view of the cover assembly of FIG. 23.

FIG. 25 is a rear view of the cover assembly of FIG. 23.

FIG. 26 is a rear perspective view of the cover assembly of FIG. 23.

FIG. 27 is a front view of a cover assembly for an air filter housing, according to an embodiment.

FIG. 28 is a perspective view of the cover assembly of FIG. 27 being installed onto an air filter housing.

FIG. 29 is a perspective view of a cover interface element of the air filter housing of FIG. 28.

FIG. 30 is a side view of the filter housing of FIG. 28 that includes the cover assembly of FIG. 27.

FIG. 31 is a perspective view of an air filter housing that includes a spring-loaded clip attachment for a cover assembly, according to an embodiment.

FIG. 32 is a partial perspective view of the spring-loaded clip attachment of the air filter housing of FIG. 31.

FIG. 33 is a side view of the air filter housing of FIG. 31 with the cover assembly installed onto the filter housing.

FIG. 34 is a perspective view of an air filter assembly, according to another embodiment.

FIG. 35 is a perspective view of the air filter assembly of FIG. 34 during an assembly operation.

FIG. 36 is a perspective view of an air filter assembly, according to another embodiment.

FIG. 37 is a perspective view of the air filter assembly of FIG. 36 during a first portion of a filter replacement operation.

FIG. 38 is a perspective view of the air filter assembly of FIG. 36 during a second portion of a filter replacement operation.

FIG. 39 is a front view of a cover assembly of an air filter housing that includes a service indicator dial, according to an embodiment.

FIG. 40 is a perspective view of an air filter assembly including a filter element supported therein by side caps, according to an embodiment.

FIG. 41 is a perspective view of the air filter assembly of FIG. 40 during assembly of the filter element.

FIG. 42 is a perspective view of the air filter assembly of FIG. 40 during installation of the filter element into an air filter housing.

FIG. 43 is a perspective view of a rail system for an air filter assembly, according to an embodiment.

FIG. 44 is a front view of the rail system of FIG. 43.

FIG. 45 is a perspective view of an air filter assembly that includes a rail system for mounting a filter element into an air filter housing, according to an embodiment.

FIG. 46 is a front view of the air filter assembly and rail system of FIG. 45.

FIG. 47 is a front view of the rail system of FIG. 45.

FIG. 48 is a perspective view of the air filter assembly of FIG. 45 during assembly of the filter element into the air filter housing.

FIG. 49 is a perspective view of an air filter assembly that includes a rail system for mounting a filter element into an air filter housing, according to another embodiment.

FIG. 50 is a perspective view of the air filter assembly of FIG. 49 during installation of the filter element onto the rail system.

FIG. 51 is a perspective view of the air filter assembly of FIG. 49 during installation of the filter element into the air filter housing.

FIG. 52 is a perspective view of an air filter assembly that includes a rail system for mounting a filter element into an air filter housing, according to another embodiment.

FIG. 53 is a perspective view of the air filter assembly of FIG. 52 during installation of the filter element onto the rail system.

FIG. 54 is a perspective view of the air filter assembly of FIG. 52 during installation of the filter element into the air filter housing.

FIG. 55 is a perspective view of a rail system for an air filter assembly, according to another embodiment.

FIG. 56 is a front view of the rail system of FIG. 55.

FIG. 57 is a perspective view of an air filter assembly that includes a rail system for mounting a filter element into an air filter housing, according to another embodiment.

FIG. 58 is a perspective view of the air filter assembly of FIG. 57 during installation of the filter element onto the rail system.

FIG. 59 is a partial perspective view of the air filter assembly of FIG. 57 showing a spring clip element of the rail system, according to an embodiment.

FIG. 60 is a partial perspective view of the rail system of FIG. 57 showing the filter element fully installed into the air filter housing.

FIG. 61 is a perspective view of an air filter assembly that includes a rail system having curved sidewalls, according to an embodiment.

FIG. 62 is a partial perspective view of the rail system of FIG. 61.

FIG. 63 is a perspective view of the air filter assembly of FIG. 61 during installation of a filter element into the air filter assembly.

FIG. 64 is a perspective view of a perspective view of an air filter assembly that includes a rail system for mounting a filter element into an air filter housing, according to another embodiment.

FIG. 65 is a perspective view of an air filter assembly that includes a rail system for mounting a filter element into an air filter housing, according to yet another embodiment.

FIG. 66 is a side cross-sectional view of an air filter assembly that includes a rail system for mounting a filter element into an air filter housing, according to yet another embodiment.

FIG. 67 is side view of the rail system of FIG. 66.

FIG. 68 is a perspective view of a rail system for mounting a filter element into an air filter housing, according to yet another embodiment.

FIG. 69 is a side view of the rail system of FIG. 68.

FIG. 70 is a perspective view of an air filter housing that includes a cover assembly with integrated filter media supports, according to an embodiment.

FIG. 71 is a perspective view of an air filter assembly that includes the air filter housing of FIG. 70.

FIG. 72 is a perspective view of the air filter assembly of FIG. 71 showing an interface between the filter element and the cover assembly.

FIG. 73 is a partial perspective view of an air filter housing that includes a cover assembly with integrated filter media supports, according to another embodiment.

FIG. 74 is a perspective view of the air filter housing of FIG. 73.

FIG. 75 is a perspective view of an HVAC system during installation of an expandable filter element into a filter assembly, according to an embodiment.

FIG. 76 is a side view of the filter assembly of FIG. 75 showing the filter element in a collapsed position and an expanded position, according to an embodiment.

FIG. 77 is a perspective view of an air filter assembly including an automatic feed system, according to an embodiment.

FIG. 78 is a perspective view of the air filter assembly of FIG. 77 shown with the media housing removed from the air filter assembly.

FIG. 79 is a perspective view of the air filter assembly of FIG. 77 during a media feed operation.

FIG. 80 is a top view of the air filter assembly of FIG. 77 during the media feed operation.

FIG. 81 is a perspective view of the air filter assembly of FIG. 77 showing an automatic media feed operation.

FIG. 82 is a perspective view of a filter media pack that includes a sealing material, according to an embodiment.

FIG. 83 is a perspective view of an air filter housing that includes a flow element, according to an embodiment.

FIG. 84 is a perspective view of the flow element of FIG. 83.

FIG. 85 is a perspective view of a flow element for use in with an air filter housing, according to another embodiment.

FIG. 86 is a side view of the flow element of FIG. 85.

FIG. 87 is a perspective view of an air filter housing that includes a flow element, according to another embodiment.

FIG. 88 is a perspective view of the flow element of FIG. 87.

FIG. 89 is a side view of the flow element of FIG. 89.

FIG. 90 is a perspective view of an air filter housing that includes a flow element, according to yet another embodiment.

FIG. 91 is a perspective view of the flow element of FIG. 90.

FIG. 92 is a front perspective view of a support element and an alignment element for a rail system of an air filter assembly, according to an embodiment.

FIG. 93 is a front perspective view of a support element and an alignment element for a rail system of an air filter assembly, according to another embodiment.

FIG. 94 is a rear perspective view of the support element and the alignment element of FIG. 93.

FIG. 95 is a bottom perspective view of the support element and the alignment element of FIG. 93.

FIG. 96 is a front perspective view of the alignment element of FIG. 93.

FIG. 97 is a rear perspective view of the alignment element of FIG. 93.

FIG. 98 is a top perspective view of the alignment element of FIG. 93.

FIG. 99 is a front perspective view of the support element of FIG. 93.

FIG. 100 is a rear perspective view of the support element of FIG. 93.

FIG. 101 is a top perspective view of the support element of FIG. 93.

FIG. 102 is a front perspective view of a support element and an alignment element for a rail system of an air filter assembly, according to yet another embodiment.

FIG. 103 is another front perspective view of the support element and the alignment element of FIG. 102.

FIG. 104 is a bottom perspective view of the alignment element of FIG. 102.

FIG. 105 is a bottom view of the alignment element of FIG. 102.

FIG. 106 is a front view of the alignment element of FIG. 102.

FIG. 107 is a front perspective view of the support element of FIG. 102.

FIG. 108 is a rear perspective view of the support element of FIG. 102.

### DETAILED DESCRIPTION

Many buildings include heating, ventilation, and air conditioning (HVAC) equipment to condition air within the building and to allow exchange of air with an environment surrounding the building. The HVAC equipment may include a filter to remove contaminants, such as dirt, pollen, and other particulate from the air entering the building and during recirculation of indoor air to improve overall air quality within the building. These filters may include a filter housing that directs air through a filter element having filter media to remove contaminants from air entering the HVAC equipment (e.g., a furnace, an air conditioning system, a dehumidifier, etc.). During operation, the filter media traps contaminants from air passing through the filter media, which can build up in the pores of the filter media, leading to increased restriction and pressure drop across the filter assembly, ultimately requiring replacement of the filter element.

Referring generally to the figures, air filter assemblies for HVAC systems are provided that include a unique interface(s) for (i) securing an air filter housing of the filter assembly to a furnace and/or other ductwork, (ii) securing a filter element and/or filter media pack of the filter assembly to an air filter housing of the filter assembly, and/or (iii) securing a cover assembly of the filter assembly to an air filter housing of the filter assembly. These interface features can simplify installation of the air filter assembly to an HVAC system and servicing of the filter element during operation. These interface features can also provide modularity to enable use of the air filter assembly with different HVAC systems.

In at least one embodiment, the air filter assembly includes an air filter housing that provides an adjustable interface for coupling the air filter housing to ductwork and/or other HVAC components (e.g., a furnace, a vent assembly, a damper assembly, etc.) of an HVAC system. The air filter housing may include a repositionable and/or adjustable flange that extends across an opening of the air filter housing to thereby enable resizing of the opening based on application requirements. The adjustable flange may include slotted openings or another adjustment mechanism to enable repositioning of the adjustable flange over the opening. The adjustable flange may also include interface features, such as a mounting flange extending away from the air filter housing, that can connect to the air filter housing to ductwork and/or other HVAC components.

In at least one embodiment, the filter assembly includes a plurality of mounting elements that are configured to couple the air filter housing to the ductwork and/or other HVAC components. In some embodiments, the mounting elements include tabs that extend inwardly from an outer perimeter of an opening of the air filter housing, such as an inlet and/or outlet opening of the air filter housing, that direct air flow through the air filter housing. The tabs may be configured to bend about the outer perimeter and into engagement with other HVAC components to secure the air filter housing to the HVAC system. In some embodiments, the bendable tabs are configured to couple the air filter housing to other HVAC components without intervening fasteners. In other embodiments, the tabs include openings to enable fastening of the tabs in place after bending, which can increase the overall structural integrity of the joint between the air filter assembly and other HVAC components.

In at least one embodiment, the air filter housing includes interface features that simplify access to, and removal of, a filter element. The air filter housing may define an access opening configured to enable installation of the filter element into the housing. The filter housing may also include a notch adjoining the access opening and extending away from the access opening along a reference plane that is perpendicular to the access opening. The slot can enable viewing of, and access, to a portion of the filter element (e.g., the filter media pack, a frame support, etc.). A technician or other user can access and grab onto the portion of the filter element through the slot, which can simplify removal of the filter element from the filter housing. The cover of the air filter housing may be disposed within the slot when the cover is installed onto the air filter housing to prevent air leakage through the air filter housing during operation.

In some embodiments, the cover forms part of a cover assembly that is pivotally coupled to a first end of the access opening of the air filter housing. A second end of the cover may be magnetically coupled to the air filter housing. For example, the second end of the cover may include at least one magnet that is configured to pull the cover toward a magnetic or ferromagnetic material on the air filter housing adjacent to the access opening. In other embodiments, the at least one magnet is coupled to the housing instead of the cover. In other embodiments, the air filter housing may include a spring-loaded clip coupled to the air filter housing proximate to the access opening. The spring-loaded clip may be configured to engage an opening of the cover when the cover is installed onto the air filter housing.

In some embodiments, the cover includes interface features configured to improve utilization of the filter element within the air filter housing. For example, the cover may define a channel extending along a side of the air filter housing when the cover is fully installed onto the air filter housing. The air filter assembly may include a filter element that is wider than the air filter housing and that extends into the channel and sealingly engages the cover. The channel may be sized to allow air flow through a portion of the filter media pack that is disposed within the channel, so as to increase the overall media area within the filter housing, which can decrease air flow velocity through the filter media pack (which can increase filtration efficiency), while also increasing the dust loading capacity of the air filter element.

In some embodiments, the cover includes an interface feature that is configured to directly couple the cover to the filter element. The interface feature may be configured so that, during removal of the cover, the interface feature causes the filter element to slide or otherwise move out of the air filter housing, which can facilitate servicing operations.

In at least one embodiment, the air filter assembly includes a filter-housing interface that is configured to simplify installation of the filter element into the air filter housing. In general, air filter housings may include a rail system that engage with an endplate structure of a filter element (e.g., a frame element, a support element, an endplate, an endcap, etc.) of a filter element to secure the filter element in place within an air filter housing. The filter-housing interface of the present application may include a snap-fit interface that simplifies installation of the filter element onto the rail system. The user may then slide the filter element along the rail system and into the housing. In some embodiments, the snap-fit interface includes a clip member disposed on a frame element of the filter element (e.g., a filter element endplate, etc.). The clip member is configured to clip onto a rail member of the rail system in response to an applied force in a first direction (e.g., along an expansion direction of a filter media pack of the filter element) between the clip member and the rail member to slidably engage the frame element to the rail member along a second direction that is substantially perpendicular to the first direction. Among other benefits, such an arrangement reduces an amount of pre-alignment between the frame element and the rail member during installation operations, which can reduce installation time and complexity.

In at least one embodiment, the frame element includes only a single mating or interface feature that engages with the rail member. For example, the frame element may include a ‘T’ shaped attachment member having a reduced width relative an overall width of the frame element. The attachment member may be configured to insert into channel defined by a rail member in the air filter housing. The rail member and/or attachment member may include lead-ins to facilitate engagement between the rail member and the attachment member and to reduce the amount of pre-alignment required during installation.

In at least one embodiment, a cover assembly of an air filter housing may form part of the filter element. The cover assembly may support a filter media pack of the filter element during installation, and removal of, the filter element from the air filter housing. In some embodiments, the cover assembly includes a base panel (e.g., cover base, etc.) that is sized to cover the access opening of the air filter housing. The cover assembly may also include at least one support shaft extending away from the base panel and into an interior cavity of the air filter housing. The filter media pack may be coupled to, and supported by, the at least one support shaft within the interior cavity. In some embodiments, the support shaft extends between opposing ends of the air filter housing and engages the air filter housing at an opposite end of the housing as the base panel. Such an arrangement can eliminate the need for separate frame elements (e.g., endplates, etc.) to support the filter element within the air filter housing, and can reduce the number of steps required to install and remove the filter element.

In some embodiments, the endplate structure and/or the installation guide include magnetic materials arranged to simplify alignment of the endplate structure with the installation guide during installation operations. The magnetic materials may also facilitate installation and/or operation of other parts of the air cleaner housing, such as by securing a cover of the air filter housing in place after installation of a filter element. These and other advantages of the various embodiments provided herein are described in more detail with respect to the figures.

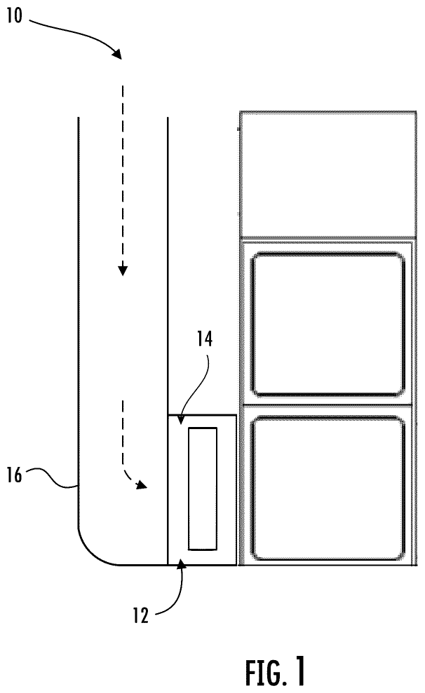

As shown in FIG. 1, an air filter assembly 12 for an HVAC system 10 for a building is provided that filters incoming air from an environment surrounding the building to produce clean, filtered, indoor air. The HVAC system may be configured to condition (e.g., heat, cool, humidify, dehumidify, etc.) air a residential or commercial building, such as an apartment, an office building, a house, or another building type. In various embodiments, the air filter assembly 12 includes an air filter housing 14 that supports the filter element within the HVAC system 10. A first end (e.g., an inlet end, etc.) air filter housing 14 is coupled to ductwork 16, which may be a return air duct configured to recirculate indoor air through the air filter assembly 12, a vent air duct configured to provide unfiltered outdoor air to the air filter assembly 12, or a combination thereof. A second end (e.g., an outlet end, etc.) of the air filter assembly 12 is coupled to a furnace to provide a source of clean filtered air to the furnace. In other embodiments, the air filter assembly 12 may be coupled to other components of an HVAC system. For example, the air filter housing 14 may be coupled to an air vent within the building to filter air entering the HVAC system through the return vent. In other embodiments, the air filter housing 14 may be coupled to a dehumidifier assembly or to another piece of HVAC equipment. In yet other embodiments, the air filter housing 14 may be coupled to a damper assembly or at a fresh air vent that fluidly couples the building to the outdoor environment.

The size and arrangement of the ductwork and furnace may be different depending on application requirements (e.g., flow rate requirements, building size, a location of the HVAC system within the building, etc.). For example, the size of the ductwork and/or openings in the furnace (or other HVAC equipment) will increase for higher flow rate applications. The types of connections that may be used to fasten or otherwise couple the air filter housing 14 to the HVAC system may also be different in various embodiments.

In some embodiments, the air filter assembly includes a support member (e.g., a rail system, a cover assembly, etc.) that is configured to support at least a portion of the filter media pack of the filter element in a non-perpendicular orientation relative to a flow direction through the air filter housing within an interior cavity of the filter housing, as will be further described.

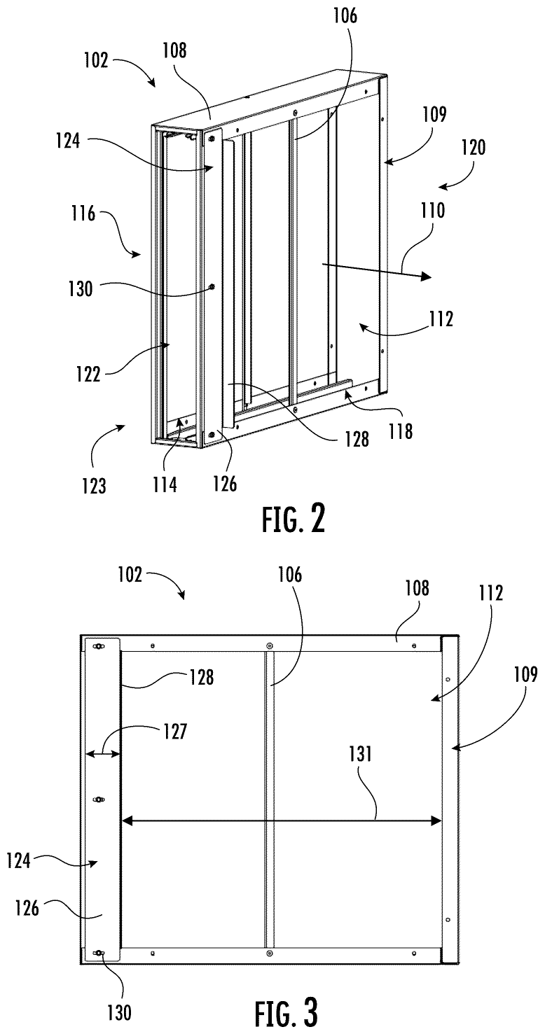

Referring to FIGS. 2 and 3, an air filter housing 102 is shown that includes, or is adapted to support, a filter element in an air flow through a portion of an HVAC system, according to an embodiment. The air filter housing 102 includes at least one adjustment mechanism that is configured to allow use of the air filter housing 102 in a variety of different HVAC system sizes and arrangements.

The air filter housing 102 may be disposed along ductwork of the HVAC system, between a heating and/or cooling element and an inlet air duct that is configured to supply air to the heating and/or cooling element (as shown in FIG. 1). The inlet air duct may be coupled to a vent line that fluidly couples the HVAC system with an environment surrounding the building, and/or a return line that is configured to recirculate air from within the building to the heating and/or cooling element. The heating and/or cooling element may include a furnace, an air conditioner, a dehumidifier, or another piece of air quality and/or conditioning equipment.

In some embodiments (see FIG. 1), the air filter housing 102 may be directly coupled to an inlet of the heating and/or cooling element of the HVAC system 10. In other embodiments, the air filter housing 102 may be disposed in an area of the inlet air duct that is spaced apart from the heating and/or cooling element. In other embodiments, the air filter housing 102 may be disposed in another location of the HVAC system, such as at an opening of a vent line for the HVAC system, a return grill location(s) in which air from a space within the building is returned to the HVAC system, or any other location at which a source of clean, filtered air is desired.

The air filter housing 102 of FIGS. 2 and 3 is configured to house the filter element therein, and to facilitate installation of the filter element into the air filter housing 102, and removal therefrom. The air filter housing 102 includes a frame 106, and a plurality of sidewalls 108 coupled to the frame 106. The sidewalls 108 enclose at least three sides of the frame 106, including a lower side (e.g., horizontally-oriented side, a floor of the air filter housing 102, etc.), a longitudinal side extending perpendicular to a flow direction 110 through the air filter housing 102 (e.g., a vertically-oriented side), and an upper side that is spaced vertically apart from, and oriented parallel to, the lower side. Together, the frame 106 and the plurality of sidewalls 108 form an enclosure 109 (e.g., a cabinet, etc.) that defines an interior cavity 112 sized to receive a filter element therein. The enclosure 109 further defines a plurality of duct openings, including a first opening 114 (e.g., an inlet opening, etc.) at a first lateral end 116 of the interior cavity 112, and a second opening 118 (e.g., an outlet opening, etc.) at a second lateral end 120 of the interior cavity 112 opposite the first lateral end 116.

In some embodiments, the first opening 114 is configured to be fluidly coupled to ductwork such as an inlet air duct and the second opening 118 is configured to be fluidly coupled to the heating and/or cooling element of the HVAC system (e.g., a furnace, an air conditioning unit, a humidifier, a dehumidifier, etc.). In other embodiments, the orientation of the first opening 114 and the second opening 118 may be reversed (e.g., the first opening 114 may be arranged as the second opening 118 for the filter assembly, etc.). The frame 106 and the plurality of sidewalls 108 also define an access opening 122 at a longitudinal end 123 of the interior cavity 112 that is configured to receive a filter element therethrough.

The air filter housing 102 includes an adjustment mechanism that is configured to allow a user to selectively adjust a size of the air flow opening (e.g., the duct opening, etc.) at the inlet or outlet of the air filter housing 102. In the embodiment of FIGS. 2-3, the air filter housing 102 includes an adjustable flange 124 that extends across the duct opening (e.g., the second opening 118) of the air filter housing 102 between opposing ends of the duct opening. The adjustable flange 124 is disposed proximate to the access opening 122 and extends along a first direction (e.g., a transverse direction that is perpendicular to the flow direction 110 and the longitudinal direction) that is substantially parallel to an edge of the access opening 122.

In the embodiment of FIGS. 2-3, the adjustable flange 124 is a thin rectangular plate having an approximately uniform thickness along its length. The adjustable flange 124 includes a base flange 126 that is engaged with an outer surface of at least one sidewall of the air filter housing 102, and an interface flange 128 that extends perpendicular to the base flange 126 along an outer edge of the base flange 126. The base flange 126 and the interface flange 128 together define an ‘L’ shaped bracket. In other embodiments, the shape and/or size of the adjustable flange 124 may be different. The base flange 126 and the interface flange 128 may be integrally formed as a monolithic structure from a single piece of material (e.g., a bent plate, etc.). In other embodiments, the interface flange 128 may be formed separately from the base flange 126 and welded or otherwise coupled to the base flange 126.

The adjustable flange 124 covers a first area of the second opening 118 along an entire height of the air filter housing 102. The adjustable flange 124 is movably coupled to at least one of the frame 106 or the sidewalls 108 (i.e., to one or both of the frame 106 and the sidewalls 108), and is movable between a first position covering the first area of the second opening 118, and a second position covering a second area of the second opening 118 that is greater than the first area.

In some embodiments, the adjustable flange 124 is slidably engaged with the enclosure 109. The adjustable flange 124 includes a plurality of elongated slots 130 to fasten or otherwise couple the adjustable flange 124 to the enclosure. The elongated slots 130 allow movement of the adjustable flange 124 relative to the enclosure 109 along the longitudinal direction to adjust the size of the second opening 118. In other embodiments, the enclosure 109 includes different sets of holes so that the adjustable flange 124 may be fastened to the enclosure 109 at different locations. In yet other embodiments, the adjustable flange 124 includes another type of slidable or movable coupling that allows a user to reposition the adjustable flange 124 with respect to the enclosure 109. For example, the air filter housing 102 may include at least one mechanical snap and/or tab (e.g., a set of mating mechanical snaps and/or tabs) that couple the adjustable flange 124 to the enclosure 109, which would eliminate the need for separate fasteners.

The base flange 126 at least partially defines the second opening 118. In the embodiment of FIGS. 2-3, the base flange 126 defines a longitudinal edge of the second opening 118. In some embodiments, a width 127 of the base flange 126 may be approximately 2 in., 3 in., 4 in., or within a range between and including any of the foregoing values. For example, a width 127 of the base flange 126 may be approximately 2 in. and may be movable in a longitudinal direction by a distance of approximately 1 in. to adjust a width 131 of the second opening 118 within a range between, and including, 23 in. to 24 in. In other embodiments, the width of the adjustable flange 124 may be different. In one embodiment, the air filter housing 102 includes multiple adjustable flanges 124 that are stacked or otherwise positioned on top of one another, and movable relative to each other, so that the adjustable flanges 124 can telescope out across the second opening 118 to cover a wider overall range than a width of an individual one of the adjustable flanges 124. In such an implementation, the adjustable flanges 124 may be plates that are oriented substantially parallel to one another.

The interface flange 128 is configured to facilitate movement of the base flange 126 with respect to the enclosure 109. In some embodiments, the interface flange 128 is disposed on an innermost longitudinal edge of the base flange 126, adjacent a perimeter of the second opening 118. In other embodiments, the location of the interface flange 128 along the base flange 126 may be different. In some embodiments, the interface flange 128 includes openings, clips, or other fasteners that are configured to couple the interface flange 128 to ductwork and/or other HVAC components to the air filter housing 102. Among other benefits, the adjustable flange 124 enables resizing of the second opening 118 based on application requirements and thereby improves modularity of the air filter assembly. In some embodiments, the air filter housing 102 also includes at least one seal member, such as a foam gasket or another sealing material, that is coupled to the adjustable flange 124 and that is configured to ensure an airtight seal between the enclosure 109 and the ductwork and/or other HVAC components.

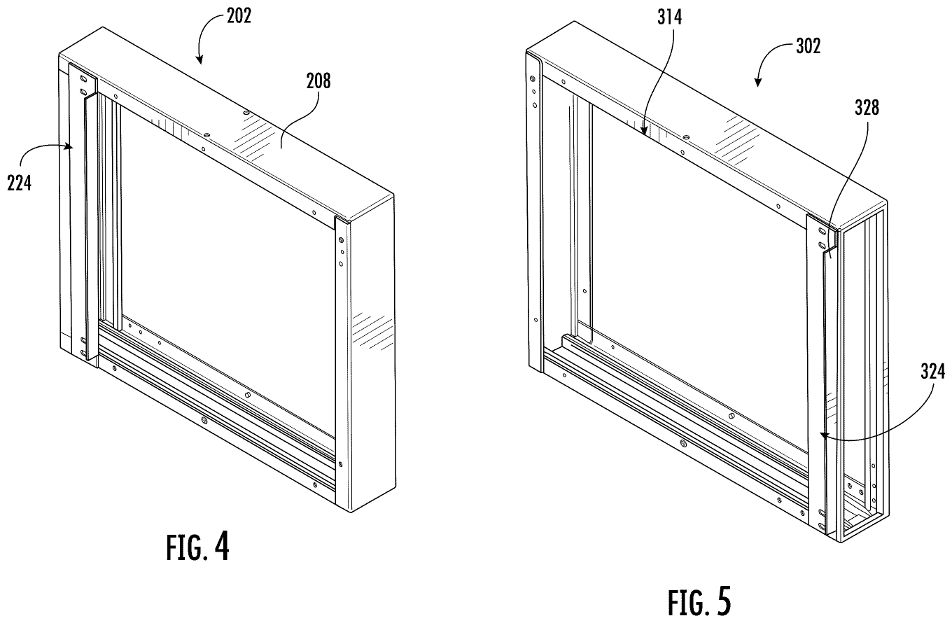

FIG. 4 show another example embodiment of an air filter housing 202 that also includes an adjustment flange 224 that is configured to resize a duct opening of the air filter housing 202. Like the embodiment of FIGS. 2-3, the adjustment flange 224 extends along a transverse direction proximate to an access opening of the air filter housing 202. In other embodiments, the orientation of the adjustment flange may be different 224. For example, FIG. 5 shows an air filter housing 302 that includes an adjustment flange 224 disposed along a first opening 314 of the air filter housing 302, in a reverse orientation from that shown in FIG. 4. An interface flange 328 of the adjustment flange 324 is disposed proximate to the access opening instead of along a perimeter edge of the first opening 314. Such an arrangement can facilitate access to the interface flange 328 and can simplify repositioning of the adjustment flange 324 in certain applications. Additionally, such an arrangement allows more flexibility when trying to align the air filter housing 102 to the ductwork and/or another HVAC component. Such an arrangement can also facilitate mounting an HVAC duct to the air filter housing 302. In the embodiment of FIG. 4, the interface flange 328 is shorter than an overall length of the adjustment flange 324, which enables flipping the adjustment flange 324 so that the interface flange 328 faces inward and through the first opening 314, which can prevent interference between the interface flange 328 and other components in certain applications.

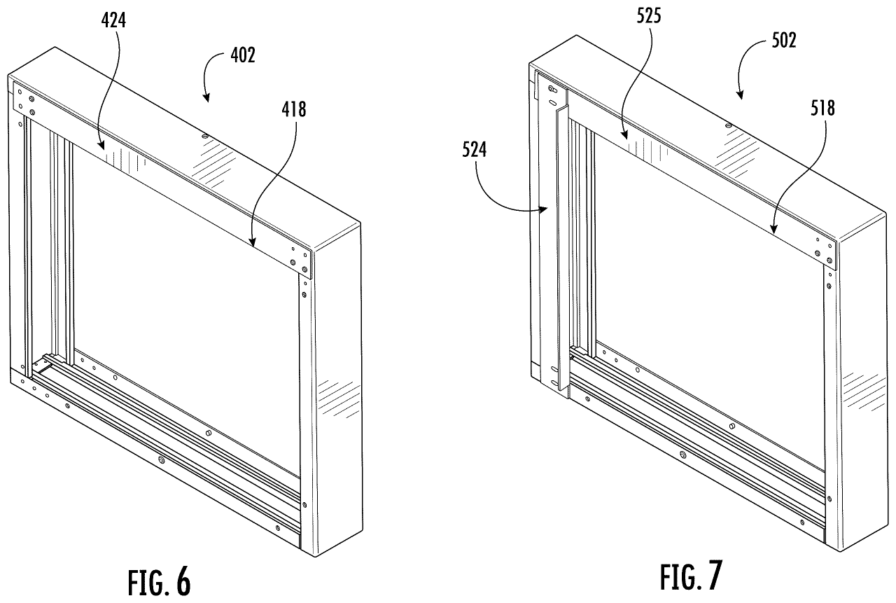

Referring to FIG. 6, an air filter housing 402 is shown that includes an adjustable flange 424 extending along a longitudinal direction (e.g., horizontally) between opposing longitudinal ends of the air filter housing 402. In some embodiments, the adjustable flange 424 also includes an interface flange formed by a bend in the adjustable flange 424 or by coupling a separate tab or panel to a base flange of the adjustable flange 424 as described with respect to FIGS. 4-5. Among other benefits, the arrangement of the adjustable flange 424 in FIG. 6 allows a user to adjust a height of the second opening 418 instead of a width of the second opening 418.

Referring to FIG. 7, an air filter housing 502 is shown that includes two adjustable flanges, including a first adjustable flange 524 extending in a transverse direction adjacent to the access opening, and a second adjustable flange 525 extending perpendicular to the first adjustable flange 524 in a longitudinal direction across the second opening. Such an arrangement enables resizing of both a height and a width of the second opening 518 independently from one another. It should be appreciated that the size, number, and arrangement of adjustable flanges for the air filter housing may be different in various embodiments.

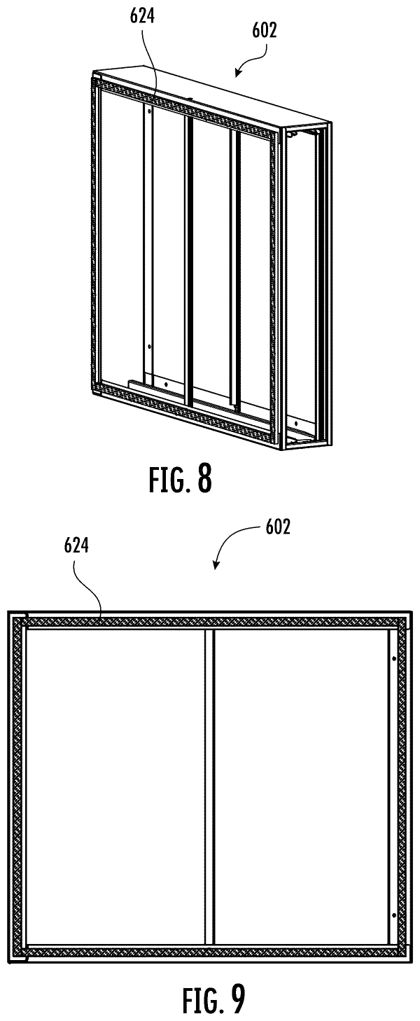

In at least some embodiments, the air filter housing includes at least one integrated seal member configured to sealingly engage the air filter housing with other HVAC components. Referring to FIGS. 8-9, an air filter housing 602 that includes an integrated seal member 624 is shown, according to an embodiment. The seal member 624 is coupled to the enclosure of the air filter housing 602 along an entire outer perimeter of a duct opening. In some embodiments, the seal member 624 is coupled to the frame and/or the plurality of sidewalls of the air filter housing 602. In at least one embodiment, the seal member 624 is formed from a single piece of material. In other embodiments, the seal member 624 is formed from multiple pieces and/or strips of seal member material that extend along a discrete edge of the duct opening. In the embodiment of FIGS. 8-9, the seal member 624 is coupled to surfaces of the enclosure that face a flow direction through the duct opening such that the seal member 624 is disposed between the air filter housing 602 and the HVAC component when the air filter housing 602 is fully installed into the HVAC system.

The seal member 624 may be made from a non-porous foam, insulation, or another type of gasket material. The seal member 624 may be coupled to the enclosure via an adhesive material (e.g., double sided adhesive tape, glue, etc.) and/or magnetic strips that are coupled to the seal member 624 and that interact with the ferromagnetic material and/or another magnetic material on the enclosure.

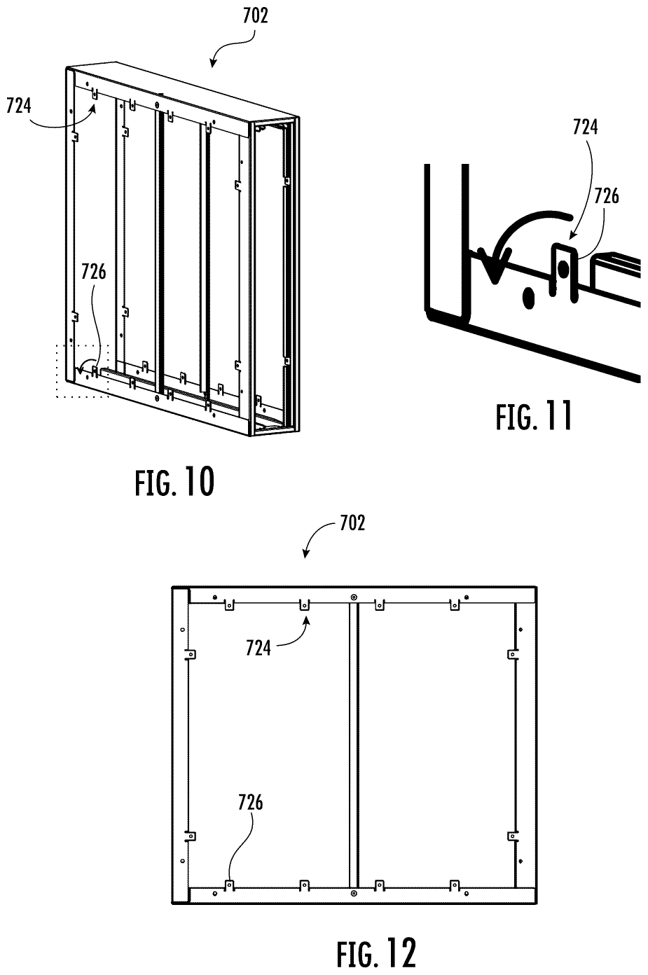

The air filter housing may also include unique interface features to couple the air filter housing to other HVAC components or to otherwise facilitate installation of the air filter housing into the HVAC system. Referring to FIGS. 10-12, an air filter housing 702 that includes a plurality of mounting elements 724 to facilitate installation and mounting of the air filter housing 702 into an HVAC system is shown, according to an embodiment. The plurality of mounting elements 724 is coupled to the enclosure at a duct opening of the enclosure (e.g., at a first opening, an inlet opening, a second opening, an outlet opening, etc.). The plurality of mounting elements 724 are coupled to the plurality of sidewalls forming the enclosure. In other embodiments, at least some of the mounting elements 724 are coupled to the frame of the enclosure. In yet other embodiments, the mounting elements 724 are movably coupled to the enclosure. For example, the mounting elements 724 may be coupled to an adjustable flange as described with respect to FIGS. 2-7 to enable movement of the mounting elements 724 to accommodate different ductwork sizes and arrangements.

In the embodiment of FIGS. 10-12, the mounting elements 724 are coupled to the sidewalls along a perimeter of the duct opening. The mounting elements 724 extend inwardly into the duct opening from the outer perimeter of the duct opening. The mounting elements 724 are spaced in approximately equal intervals along the outer perimeter. In other embodiments, the arrangement, size, and/or number of mounting elements 724 is different.

In some embodiments, the mounting elements 724 include a plurality of bendable tabs 726 that are configured to bend at a bend line disposed proximate to an outer perimeter of the duct opening. As shown in FIG. 11, the bendable tabs 726 are integrally formed with the enclosure (e.g., at least one of the plurality of sidewalls). The bendable tabs 726 may be thin rectangular-shaped strips that extend inwardly from the sidewalls. In other embodiments, the bendable tabs 726 may have a rounded profile, or may be formed in another shape.

In some embodiments, the sidewalls include slots and/or notches on either side of each of the tabs 726, such as adjacent to a location at which the tabs 726 are connected to the enclosure, which can facilitate bending of the tabs 726 relative to the sidewalls. The slots and/or notches may extend laterally across the tabs 726 from an outer edge of the tabs 726 toward one another. In the embodiment of FIG. 11, the tabs 726 are configured to be used at bent positioned of 90° and 180° from an unbent position (from a position that is parallel to the sidewalls of the enclosure. During installation, the tabs 726 may be bent over an adjacent ledge and/or wall of an HVAC component, such as a wall forming an opening to a furnace or a ductwork abutting the air filter housing 702 at the duct opening. The tabs 726 may be bent over an adjacent component to sandwich or otherwise secure the adjacent component between the tabs 726 and the enclosure. Among other benefits, the tabs 726 can eliminate the need for screws and/or other fasteners to couple the air filter housing to other HVAC components. In other embodiments, as shown in FIG. 11, the tabs 726 may include openings to enable fastening of the tabs 726 to other HVAC components. The enclosure may also include additional openings (e.g., fastener openings) to enable the use of fasteners independently from the tabs 726.

In some embodiments, the tabs 726 are integrally formed with the sidewalls from a single piece of material. For example, the sidewalls may be formed by a metal stamping operation that forms openings and tabs 726 into the sidewalls. In other embodiments, the tabs 726 are formed separately from the enclosure and are fastened, welded, or otherwise coupled to the enclosure.

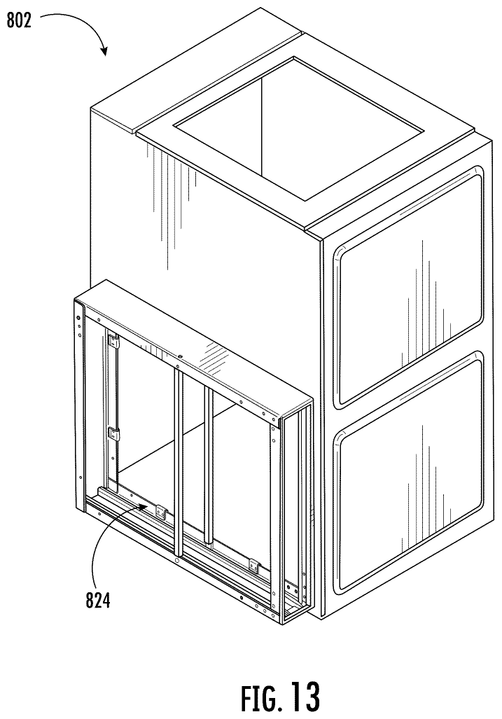

Referring to FIG. 13, an air filter housing 802 that includes a plurality of mounting clips 824 is shown, according to an embodiment. The mounting clips 824 are configured to couple the air filter housing 802 to an HVAC component such as ductwork, a furnace, or another component at a duct opening of the air filter housing 802. In some embodiments, the mounting clips 824 are configured to mount or otherwise secure the air filter housing 802 to an HVAC component without any intervening fasteners (e.g., without the use of screws, bolts, rivets, etc.). In other embodiments, the mounting clips 824 are used in combination with other fastener types, or with other mounting elements such as the bendable tabs of FIGS. 10-12.

In the embodiment of FIG. 13, the mounting clips 824 are flange clips that are inserted onto adjacent flanges and/or wall sections of the air filter housing 802 and HVAC component. The flange clips may include spring clips having a ‘U’ or ‘V’ shaped profile. The flange clips may also include detents, barbs, or other retaining features that engage with the walls on each side of the flange clip to prevent movement of the flange clip after installation. In the embodiment of FIG. 13, the flange clips are spaced at approximately equal intervals along the perimeter of the duct opening (with approximately 2 clips along each wall section). In other embodiments, the number and/or arrangement of flange clips may be different.

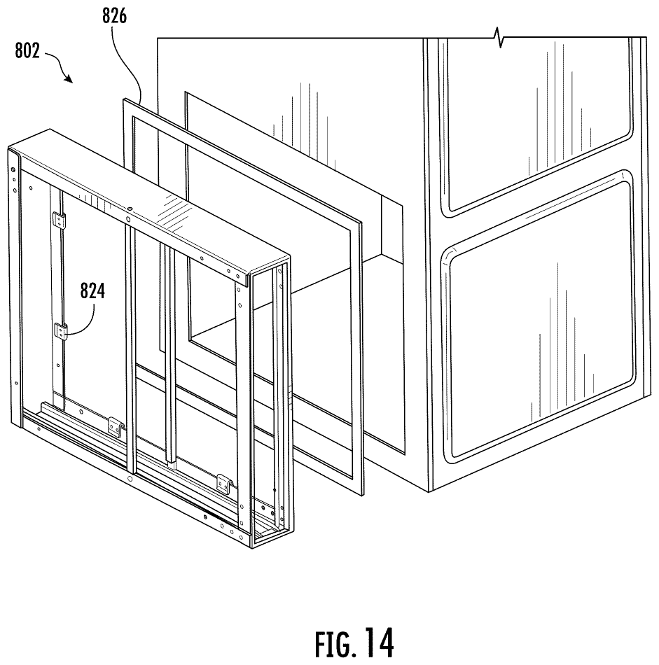

FIG. 14 shows the air filter housing 802 separated from the HVAC component. As shown, the air filter housing 802 includes a seal member 826 disposed adjacent to a perimeter of the duct opening. The seal member 826 is secured in position between the enclosure and the HVAC component by the flange clips which press the enclosure against the HVAC component. The force applied by the flange clips compresses the seal member 826 to thereby reduce the amount of air leakage between the air filter housing 802 and the HVAC components.

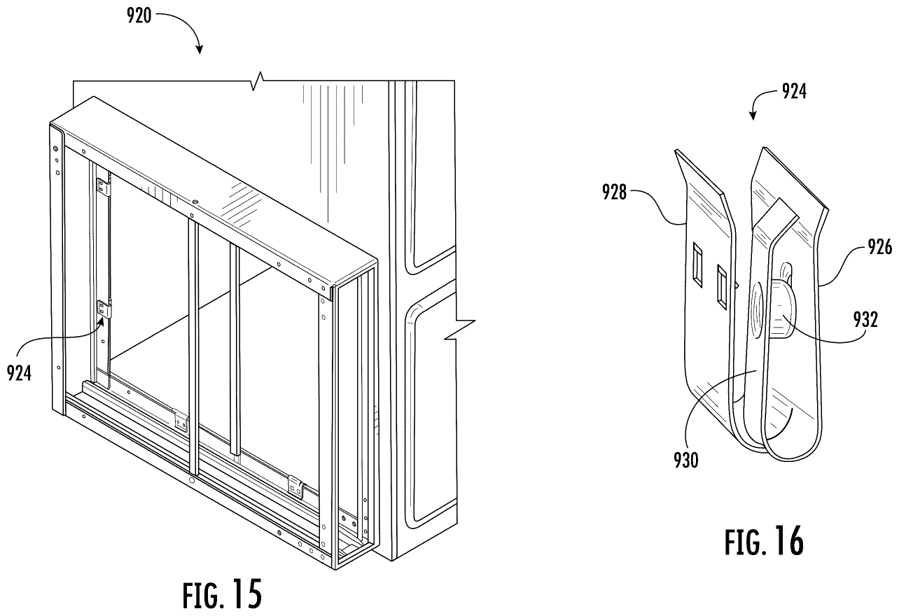

The design of the mounting clips may be different in various embodiments. Referring to FIG. 15, an air filter housing 902 that includes mounting clips 924 that provide controlled spacing between the enclosure and the HVAC component is shown, according to an embodiment. The mounting clips 924 may be disposed along the outer perimeter of the duct opening in a similar arrangement as the mounting clips 824 described with reference to FIG. 13.

As shown in FIG. 16, at least one of the mounting clips 924 includes a base tab 926 (e.g., a base portion, a base wall, etc.) and two fastener portions, shown as first fastener tab 928 (e.g., a first portion, a first wall, etc.) and second fastener tab 930 (e.g., a second portion, a second wall, etc.). The first fastener tab 928 and the second fastener tab 930 both extend substantially parallel to the base tab 926 and are offset from the base tab 926. The second fastener tab 930 is offset from the first fastener tab 928 such that the second fastener tab 930 is disposed between the base tab 926 and the first fastener tab 928. The first fastener tab 928 and the second fastener tab 930 are coupled to the base tab 926 by an arcuate section of the mounting clip 924 such that the base tab 926, the first fastener tab 928, and the second fastener tab 930 together form a spring clip.

A width of the second fastener tab 930 is less than a width of the first fastener tab 928. A combined width of the first fastener tab 928 and the second fastener tab 930 is approximately equal to a width of the base tab 926. Such an arrangement can provide greater holding force between the first fastener tab 928 and the base tab 926 as compared to the second fastener tab 930 and the base tab 926. In other embodiments, the relative widths of one or more of the base tab 926, the first fastener tab 928, and/or the second fastener tab 930 may be different.

The base tab 926 and the first fastener tab 928 each include hooks (e.g., barbs, etc.) that are angled away from free ends of the base tab 926 and the first fastener tab 928 so as to maintain engagement between the mounting clip 924 and walls of the HVAC component and the enclosure, respectively. The second fastener tab 930 defines a protrusion 932 extending toward the base tab 926. In some embodiments, the protrusion 932 is a stud (e.g., a bump-out, a dimple, etc.) that is stamped or otherwise formed into the second fastener tab 930. A free end of the second fastener tab 930 is flared toward the base tab 926 and away from the first fastener tab 928.

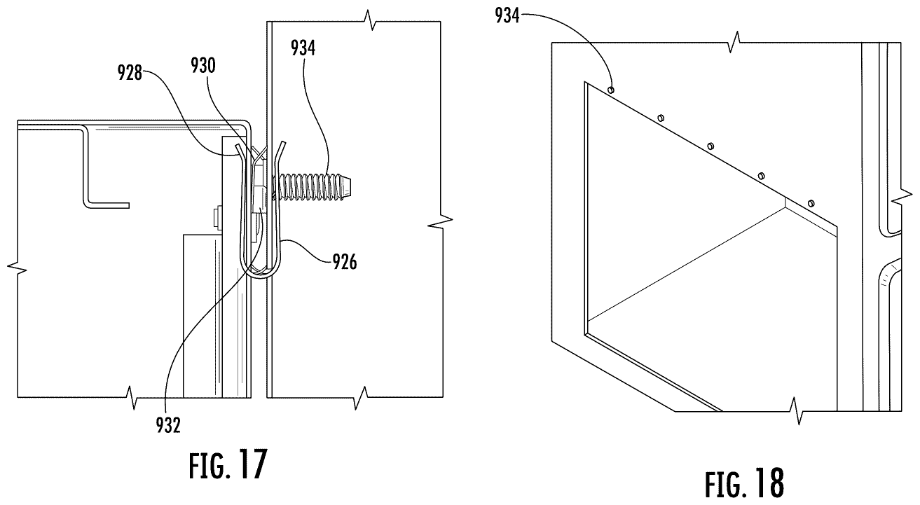

As shown in FIG. 17, the two fastener portions are configured to secure the air filter housing 902 in parallel spaced relation relative to the HVAC component. The base tab 926 is configured to engage a ledge and/or wall along a perimeter opening of the HVAC component. The first fastener tab 928 is configured to engage the enclosure sidewall at the duct opening. The base tab 926 and the first fastener tab 928 together are configured to press the enclosure toward the HVAC component. The second fastener tab 930 is configured to be received in a gap formed between the enclosure sidewall and the HVAC component. In the embodiment of FIG. 17, the second fastener tab 930 is arranged so that the protrusion 932 is engaged with the ledge and/or wall of the HVAC component. In such an arrangement, the ledge and/or sidewall of the HVAC component is pinched between the base tab 926 and the second fastener tab 930. The enclosure sidewall is disposed between the first fastener tab 928 and the second fastener tab 930.

As shown in FIG. 17, the second fastener tab 930 sets the spacing (e.g., a size of the gap) between the enclosure and the HVAC component. In at least one embodiment, a width of the gap is approximately equal to a combined width of a planar portion of the second fastener tab 930 and the protrusion 932. Among other benefits, such an arrangement accommodates existing fasteners 934 (e.g., screw heads, rivet heads, etc.) or protrusions that might be present on the HVAC component and/or the enclosure sidewall (see FIG. 18), and reduces the risk of interference between the enclosure sidewall and the fasteners, which can reduce the risk of damage during installation and/or during maintenance operations.

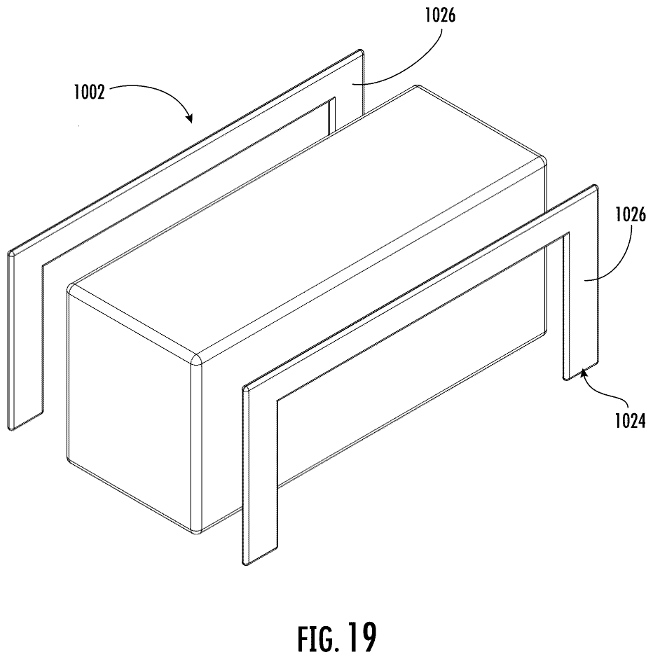

Referring to FIG. 19, an air filter housing 1002 is shown that includes an attachment rail system that is configured to simplify installation of the air filter housing, according to an embodiment. The attachment rail system 1024 includes at least one attachment rail 1026 that is configured to be secured to a ductwork, a furnace, an air conditioning unit, an air vent, or another HVAC component independently from the air filter housing 1002. The attachment rail 1026 may have a profile/shape that matches and outer profile of the air filter housing 1002 (e.g., a rectangular shape, etc.). In one embodiment, the attachment rail 1026 includes an elongated flange defining a central opening that is alignable with an opening in the ductwork. The attachment rail 1026 may be fixedly coupled to the ductwork by a plurality of fasteners such as screws, bolts, or rivets. In other embodiments, the attachment rail 1026 is bonded to the ductwork or another HVAC component using an adhesive material.

The attachment rail 1026 includes a quick-connect interface that is configured to detachably couple the air filter housing 1002 to the ductwork or another HVAC component. In the embodiment of FIG. 19, the attachment rail 1026 includes slotted openings (e.g., a keyhole hanger, etc.) that are configured to receive a stud or other protrusion of an enclosure of the air filter housing 1002. In other embodiments, another form of releasable coupling may be used to secure the enclosure to the attachment rail 1026. For example, the attachment rail 1026 and/or the enclosure of the air filter housing 1002 may include alignment pins and/or tabs, latches and/or snaps, or another releasable coupling to secure the attachment rail 1026 to the enclosure. In other embodiments, the air filter housing 1002 includes a ledge and/or hook on at least one first edge of the enclosure and a snap on at least one second edge that opposes the at least one first ledge to simplify alignment and to reduce the number of snap and/or clips.

In some embodiments, the attachment rail system 1024 includes a seal member along one or more surfaces of the attachment rail 1026. For example, the attachment rail system 1024 may include a non-porous foam, insulation, or another type of gasket material along a perimeter surface of the attachment rail 1026 that faces toward the enclosure. In other embodiments, the attachment rail 1026 may be at least partially formed from a gasket material. In yet other embodiments, the seal member is coupled to the enclosure (as shown in FIGS. 8-9).

In some embodiments (as shown in FIG. 19), the attachment rail system 1024 includes a pair of attachment rails 1026 on opposing sides of the enclosure that are configured to couple the enclosure to HVAC components on either side of the enclosure. Among other benefits, the attachment rail system 1024 can eliminate the need for fasteners (e.g., screws, bolts, rivets, clips, etc.) for securing the air filter housing 1002 to an HVAC component. The attachment rail system can also simplify removal of the enclosure from the HVAC system, which can allow access to areas of the ductwork adjacent to the air filter housing 1002 during maintenance operations, for example.

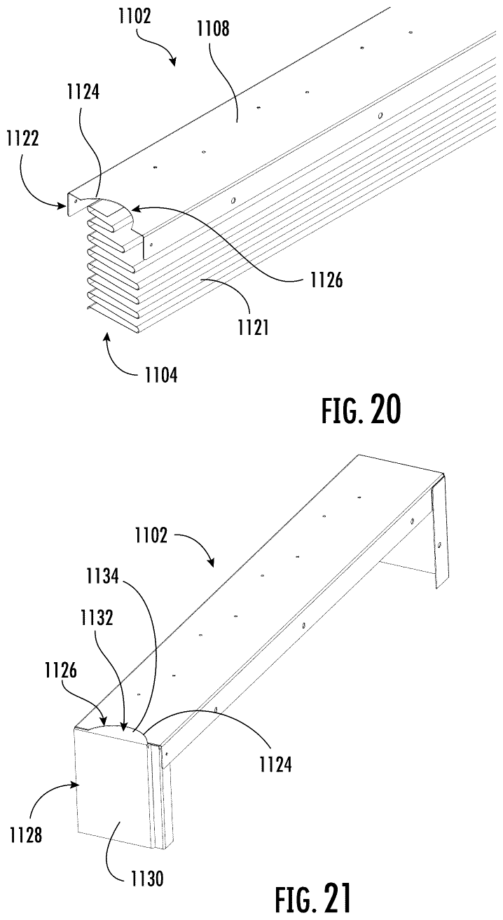

The air cleaner housing may also include interface features to facilitate installation, and removal of a filter element during servicing and/or maintenance operations. Referring to FIGS. 20-21, a portion of an air filter housing 1102 is shown that includes a keyway 1124 that increases accessibility of the filter element through an access opening 1122 of the air filter housing 1102. In the embodiment of FIGS. 20-21, the keyway 1124 is formed in an upper sidewall 1108 of the air filter housing 1102 adjacent to the access opening 1122. The upper sidewall 1108 extends away from the access opening 1122 along a longitudinal direction (e.g., horizontally when viewed parallel to a flow direction through the air filter housing).

In the embodiment of FIGS. 20-21, the keyway 1124 includes a notch 1126 (e.g., an opening, a reveal, a slot, etc.) defined by the upper sidewall 208. The notch 1126 adjoins the access opening 1122 so that the notch 1126 forms a continuous part of the access opening 1122 (e.g., a single continuous opening). The notch 1126 extends along a reference plane that is perpendicular to the access opening 1122. In the embodiment of FIGS. 20-21, the upper sidewall 1108 defines a notch 1126 having a rounded (e.g., curved, arcuate, etc.) inner edge. In other embodiments, the shape of the notch 1126 may be different.

As shown in FIG. 20, the notch 1126 provides visibility to a portion of a filter element 1104 of the air filter assembly. The notch 1126 can also facilitate removal of the filter element 1104 from the air filter housing 1102. For example, a user can grasp an exposed region of a filter media pack 1121 that is visible through the notch 1126 and/or a portion of a frame element of the filter element 1104 to facilitate removal of the filter element 1104 from the air filter housing 1102.

Referring to FIG. 21, in some embodiments, the air filter housing 1102 includes a cover assembly 1128 that is coupled to the enclosure at the access opening 1122. The cover assembly 1128 may include a cover 1130 that closes the access opening 1122 when the cover 1130 fully installed onto the air filter housing 1102. The cover 1130 defines a key 1132 that engages the notch 1126 when the cover is fully installed onto the air filter housing 1102. In the embodiment of FIG. 21, the key 1132 includes a protrusion 1134 that is disposed within the notch 1126 when the cover assembly 1128 is fully installed onto the air filter housing 1102.

The protrusion 1134 extends away from an end of the cover 1130 in a substantially perpendicular orientation relative to the cover 1130. The protrusion 1134 is shaped complementary with the notch 1126 so that the protrusion 1134 is nestably engaged with the notch 1126 when the cover assembly 1128 is fully installed onto the air filter housing 1102. In other embodiments, the shape and/or size of the notch 1126 and/or the key 1132 may be different.

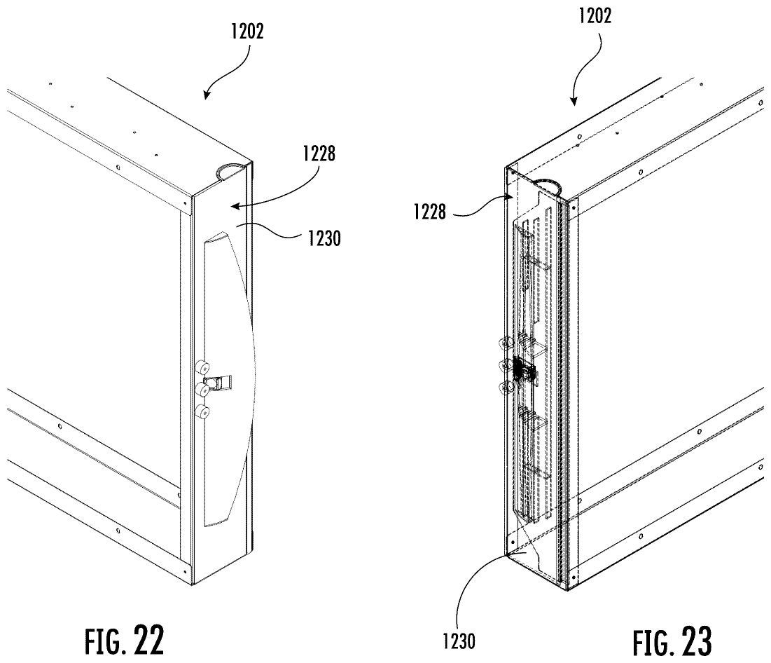

The design and arrangement of the cover assembly may be different in various embodiments. Referring to FIGS. 22-23, a cover assembly 1228 for an air filter housing is shown that includes various interface features to facilitate installation, and replacement of a filter element of the filter assembly, according to an embodiment. The cover assembly 1228 has a similar shape as the cover assembly described with reference to FIGS. 20-21. The cover assembly 1228 of FIGS. 22-23 also includes user interface features to (i) improve the strength of the connection between the cover assembly 1228 and the enclosure, and (ii) reduce or otherwise simplify user interaction with the cover during maintenance events.

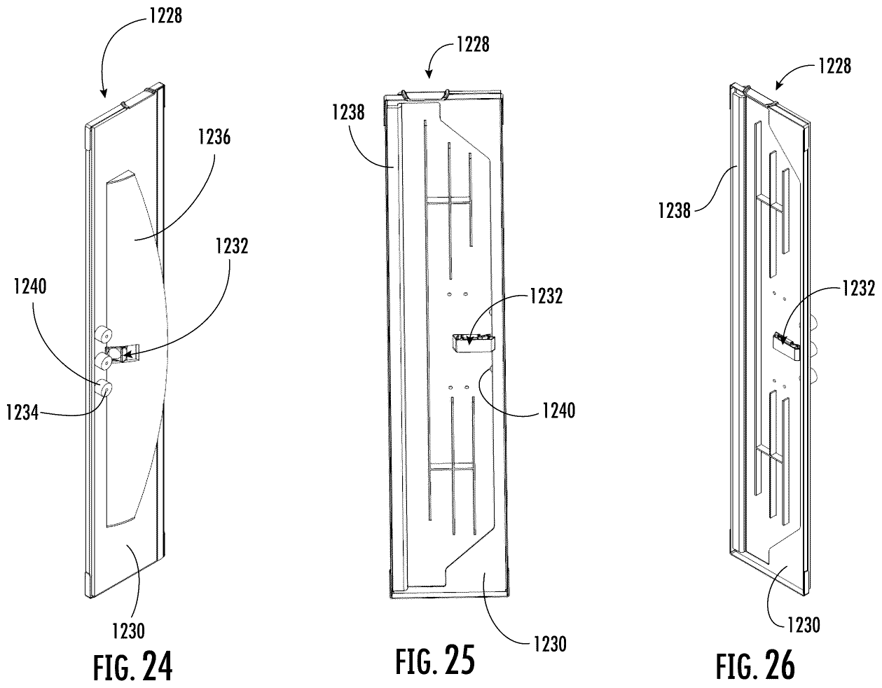

The cover assembly 1228 includes a cover 1230, a latch 1232, and a plurality of magnets 1234. In other embodiments, the cover assembly 1228 may include additional, fewer, and/or different components. As shown in FIGS. 24-26, the cover 1230 includes a plate that is configured to close off the access opening of the enclosure (e.g., along a faceplate portion of the enclosure that defines the access opening, etc.). The cover 1230 also includes a handle 1236 defining a pocket to facilitate manual manipulation of the cover by a user. In another embodiment, the cover 1230 includes a handle on each end of the cover 1230 with at least one handle defining a pass-through opening, which can simply removal in various installation configurations. The cover 1230 further includes a ledge 1238 (e.g., an offset tab, etc.) extending along a perimeter edge of the cover 1230. In some embodiments, the cover 1230 is pivotally coupled to a first end of the access opening along a transverse edge of the access opening. In other embodiments, the cover 1230 is pivotally coupled to the enclosure proximate to an edge of the access opening that extends along a flow direction through the air filter housing.

In the embodiment of FIGS. 22-23, the ledge 1238 is configured to nestably engage an inner ledge of the enclosure to couple a first end of the cover 1230 to the enclosure. In other embodiments, the coupling between the ledge 1238 and the enclosure may be different.

The latch 1232 is configured to detachably couple the cover 1230 to the enclosure. The latch 1232 is disposed proximate to a second transverse edge of the cover 1230, on an opposite end of the cover 1230 as the ledge 1238. In the embodiment of FIGS. 24-26, the latch 1232 is movably coupled to the cover 1230 to allow movement of the latch 1232 along a lateral direction relative to the cover 1230 (i.e., so that an edge of the latch 1232 moves away from the second transverse edge). The latch 1232 also includes an actuator that is configured to reposition the latch 1232 between an open position and a closed position. In the embodiment of FIGS. 24-26, the latch 1232 extends through an opening in the cover 1230 and protrudes outwardly from both sides of the cover 1230.

A first end of the latch 1232 on a first side of the cover 1230 is configured to releasably engage (e.g., latch onto) an overhanging wall sidewall of the enclosure (e.g., a faceplate overhang that defines a portion of the access opening, etc.). A second end of the latch 1232 on a second side of the cover 1230 forms an actuator for the latch 1232. In the embodiment of FIGS. 24-26, the second end of the latch 1232 extends through an opening defined by the handle 1236 at a central position along the handle 1236 that is disposed between opposing ends of the cover 1230. Such an arrangement allows a user to actuate the latch 1232 while simultaneously applying an outward force to the handle 1236 to remove the cover 1230 from the enclosure, thereby simplifying user interaction required during installation, or removal of the filter element from the air filter housing 1202. It should be appreciated that the design and arrangement of the actuation mechanism for the latch 1232 may be different in other embodiments. For example, the actuator may be configured to cause lateral movement of the latch 1232 in response to an axial force applied to the second end of the latch, in response to a user depressing the actuator toward the cover 1230.

In some embodiments, the cover assembly 1228 includes at least one magnet 1234 configured to magnetically couple the cover 1230 to the enclosure at the access opening instead of, or in addition to, the latch 1232. Referring to FIGS. 24 and 26, the cover 1230 defines a plurality of pockets 1240 (e.g., recessed areas, cavities, etc.) arranged along the second transverse edge of the cover 1230, between the handle 1236 and the second transverse edge of the cover 1230. Each of the pockets 1240 is configured to receive a respective one of the magnets 1234 therein to couple the magnets 1234 to the cover 1230.

The magnets 1234 are configured to apply a force to a ferromagnetic or magnetic material on the enclosure. For example, the magnets 1234 may be configured to interact with one or more magnets disposed on the enclosure proximate to the access opening to magnetically couple the second end of the cover assembly 1228 to the enclosure. In some embodiments, the magnets are sized so that the magnetic force overcomes the force and/or latch resistance required to fully engage the latch 1232 with the enclosure so that a user does not have to manipulate the actuator or press the cover 1230 against the enclosure to actuate the latch 1232.

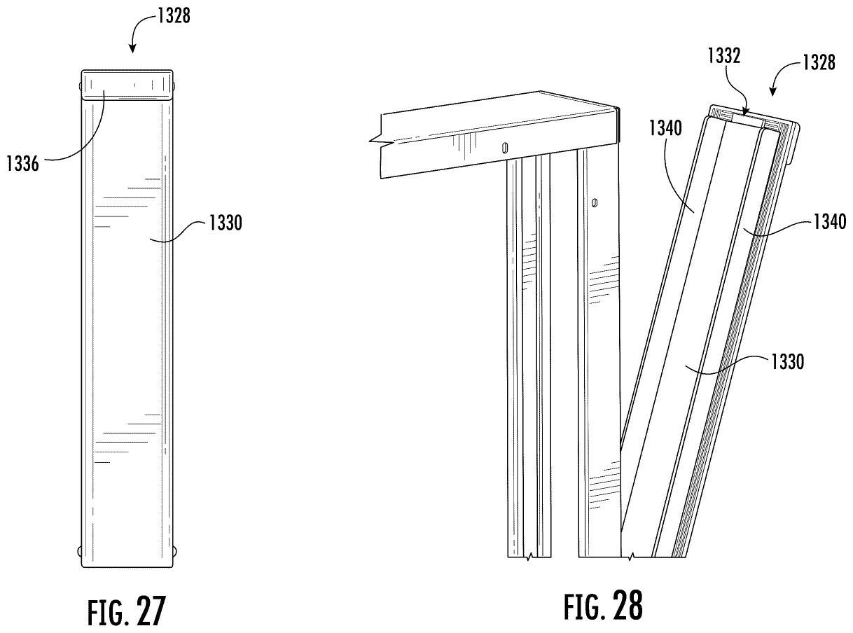

The orientation of the latch and/or magnets in the cover assembly may be different in various embodiments. For example, referring to FIGS. 27-30, a cover assembly 1328 is shown that is configured to pivot about one of an upper or lower end of the access opening, about an axis that extends parallel to a flow direction through the air filter housing, according to an embodiment. The cover assembly 1328 includes a cover 1330 and a magnet assembly 1332 including a magnet 1350 that is attached to the cover 1330.

As shown in FIGS. 27-28, the cover 1330 is configured to engage the enclosure at the access opening to close off the access opening after installation of the filter element. The cover 1330 includes a handle 1336 disposed at an upper end of the cover 1330 and extending parallel to the flow direction through the air filter housing. The cover 1330 also includes a pair of flanges 1340 disposed on an opposite side of the cover 1330 as the handle 1336. Each of the pair of flanges 1340 extends away from a planar portion of the cover 1330 in substantially perpendicular orientation relative to the planar portion of the cover 1330. Each of the pair of flanges 1340 is disposed proximate to a transverse edge of the cover 1330 and extends along a respective one of the transverse edges of the cover 1330. Together, the flanges 1340 and the planar portion of the cover 1330 define a channel having a rectangular shaped cross-section extending between the upper and lower end of the cover 1330. As shown in FIG. 28, the flanges 1340 are configured to insert into the access opening to thereby facilitate alignment between the cover assembly 1328 and the enclosure during assembly. In some embodiments, at least one of the flanges 1340 includes a tapered edge to facilitate alignment between the cover 1330 and the enclosure during assembly. In other embodiments, a distance between the flanges 1340 may be increased so that each flange 1340 engage an outer surface of the enclosure when the cover assembly 1328 is fully installed onto the enclosure.

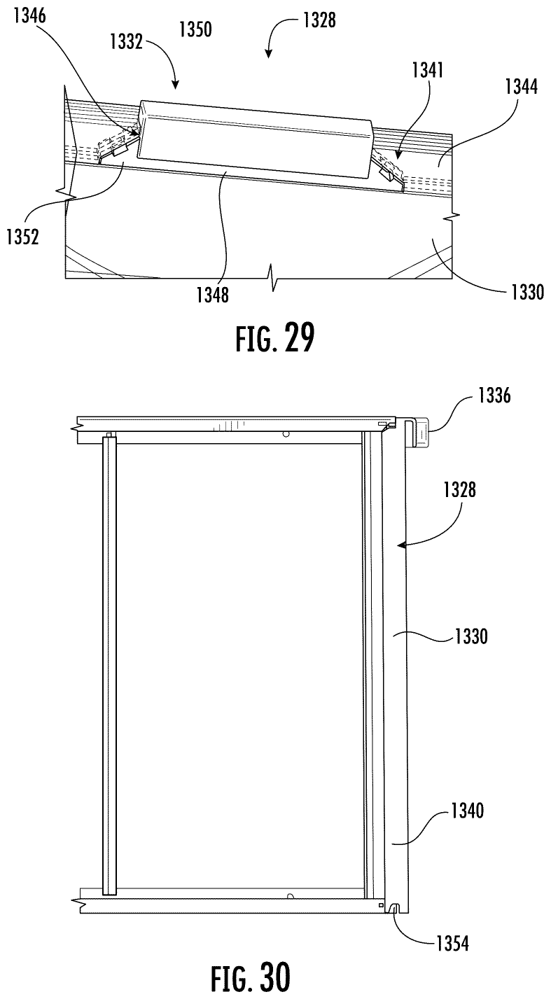

Referring to FIGS. 28-29, the magnet assembly 1332 is coupled to the cover 1330 at the upper end of the cover proximate to the handle 1336. As shown in FIG. 29, the cover 1330 includes (e.g., defines) a magnet holder 1341 on an opposite side of the cover 1330 as the handle 1336. The magnet holder 1341 includes a plurality of ribs 1344 (e.g., support members, tabs, fins, vanes, etc.) extending in a lateral direction across the upper end of the cover 1330. The ribs 1344 defines slots therebetween. Together, the ribs 1344 define a recessed area 1346 in a central region along the cover 1330. The ribs 1344 also define triangular shaped cutouts at opposing ends of the recessed area 1346. The cutouts extend from a base of the ribs where the ribs 1344 engage a planar portion of the cover 1330, to an intermediate position along a height of the ribs 1344.

The magnet assembly 1332 includes a magnet retainer 1348 and a magnet 1350 coupled thereto. The magnet 1350 is disposed in a recessed area (e.g., a slot, a depression, etc.) between opposing ends of the magnet retainer 1348. The magnet retainer 1348 includes triangular shaped mounts 1352 at either end of the magnet retainer 1348. The mounts 1352 are shaped complementary with the triangle shaped cutouts in the cover 1330 and are configured to nestably engage the cutouts to couple the magnet retainer 1348 to the cover 1330. In some embodiments, the magnet retainer 1348 also includes hooks, tabs, barbs, and/or other engaging features along the mounts 1352 that are configured to clip onto a respective one of the ribs 1344 during assembly to thereby prevent the magnet retainer 1348 from becoming separated from the cover 1330 during use.

Referring to FIG. 30, the cover assembly 1328 engages and is coupled to the enclosure at opposing ends of the enclosure (e.g., at the upper end and the lower end). In some embodiments, a lower end of the cover assembly 1328 is pivotally coupled to the enclosure. In the embodiment of FIG. 30, each of the flanges 1340 defines a slot 1354 extending in a lateral direction through a lower end of the cover 1330. The slots 1354 are aligned with one another along the lateral direction. Each of the slots 1354 engages a respective one of a pair of studs that extend away from the enclosure in the lateral direction to pivotally couple the lower end of the cover assembly 1328 to the enclosure. It should be appreciated that a different type of connection mechanism may be used to pivotally couple the cover assembly 1328 to the enclosure in other embodiments.

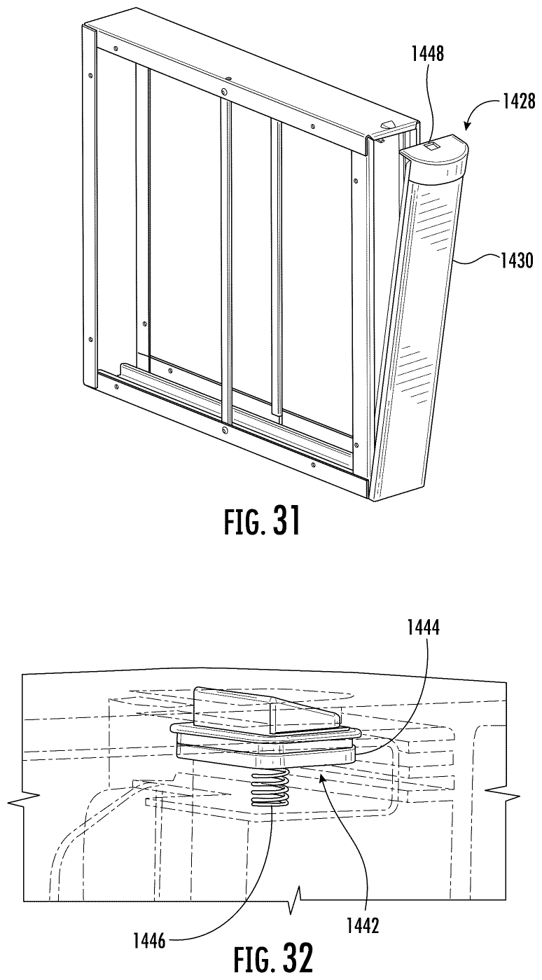

Referring to FIGS. 31-33, another example cover assembly 1428 for an air filter housing is shown that is constrained at both upper and lower ends of air filter housing when the cover assembly 1428 is fully installed onto the filter housing. Like the cover assembly of FIGS. 28-30, the cover assembly 1428 of FIGS. 31-33 is (i) pivotally coupled to an enclosure of the air filter housing at a lower end (e.g., a first transverse end, etc.) of the enclosure, and (ii) detachably coupled to the enclosure at an upper end of the enclosure (e.g., a second transverse end, etc.) that opposes the upper end.

As shown in FIG. 31, the air filter housing includes a spring-loaded clip 1442 coupled to the enclosure proximate to the access opening that is configured to detachably couple the upper end of the cover assembly 1428 to the enclosure. The spring-loaded clip 1442 includes a clip member 1444 disposed along an upper sidewall of the enclosure and extending through an opening in the upper sidewall. The clip member 1444 is movably coupled to the enclosure by a spring member 1446 that is disposed between the clip member 1444 and a ledge disposed in an interior cavity of the enclosure. The spring member 1446 may be a compression spring or a clip spring that is configured press the clip member 1444 through the opening in the upper sidewall.

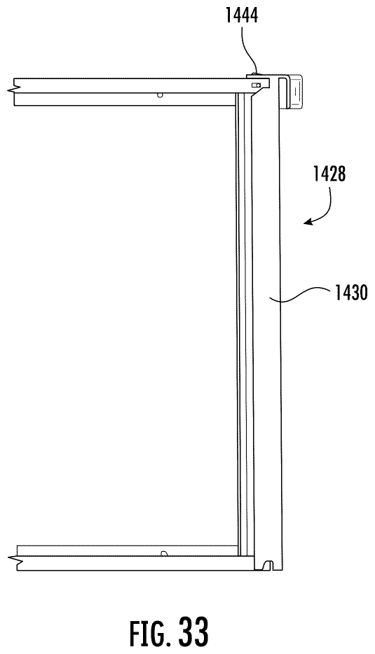

As shown in FIGS. 31 and 33, the cover 1430 defines a slot 1448 along an upper ledge of the cover 1430. The slot 1448 is configured to receive the clip member 1444 therein to detachably couple the cover 1430 to the enclosure. In some embodiments, an upper surface of the clip member 1444 is tapered to allow the cover 1430 to slidably engage the clip member 1444 when rotating the cover 1430 toward the enclosure.

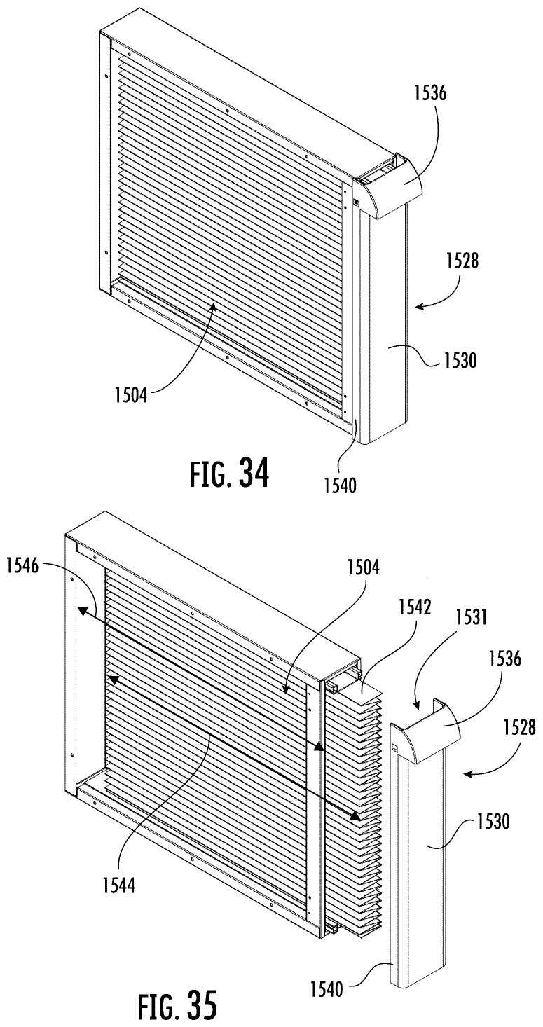

Referring to FIGS. 34-35, another example cover assembly 1528 for an air filter housing is shown. The cover assembly 1528 is configured to encompass a portion of a filter media pack 1542 of a filter element 1504 to increase the effective surface area of media for filtration within the air filter assembly.

The cover assembly 1528 includes a cover 1530. The cover 1530 includes a handle 1536 and a pair of flanges 1540. The flanges 1540 are disposed on an opposite side of the cover 1330 as the handle 1336. Each of the flanges 1540 extends away from a planar portion of the cover 1530 in substantially perpendicular orientation relative to the planar portion of the cover 1530. Each of the flanges 1540 is disposed proximate to a transverse edge of the cover 1530 and extends along a respective one of the transverse edges of the cover 1530. Together, the flanges 1540 and the planar portion of the cover 1530 define a channel 1531 having a rectangular shaped cross-section extending between the upper and lower end of the cover 1530. As shown in FIG. 35, the flanges 1540 are configured to nestably engage the enclosure when the cover assembly 1528 is fully installed onto the enclosure.

The filter element 1504 includes a filter media pack 1542 that is configured to filter particulate from air passing through the filter element 1504. A width 1544 of the filter media pack 1542 available for flow is greater than a width 1546 of the enclosure. A portion of the filter media pack 1542 extends longitudinally beyond the enclosure (and the filter frame elements/endplates) when the filter element is fully installed within the air filter housing. The portion of the filter media pack 1542 overhangs the enclosure through the access opening and extends into the channel 1531 formed by the cover 1530. The filter media pack 1542 presses against the planar portion of the cover 1530 at the base of the channel 1531 to prevent airflow around the longitudinal end of the filter media pack 1542.

Each of the flanges 1540 engages an outer surface of the enclosure when the cover assembly 1528 is fully installed onto the enclosure. A width of the channel 1531 between the flanges 1540 is greater than a width of the enclosure. In some embodiments, the cover assembly 1528 and/or enclosure includes a seal member disposed between the flanges 1540 and the enclosure to reduce air flow leakage therethrough. Such an arrangement of the cover 1530 with respect to the enclosure provides greater area/volume for flow through the channel 1531 during operation. The additional flow area provided by the cover 1530, and effective surface area of the filter media, reduces air flow velocity through the filter media pack 1542, which can increase filtration efficiency (e.g., an amount of dust removed from the air flow stream as a fraction of the total dust entering the air filter assembly). The additional filter media area also increases the dust loading capacity of the filter element 1504, which can increase the service life of the filter element 1504.

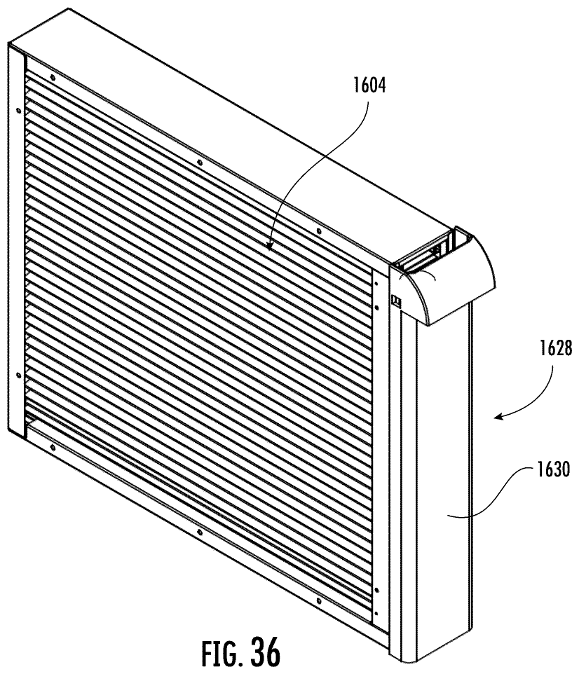

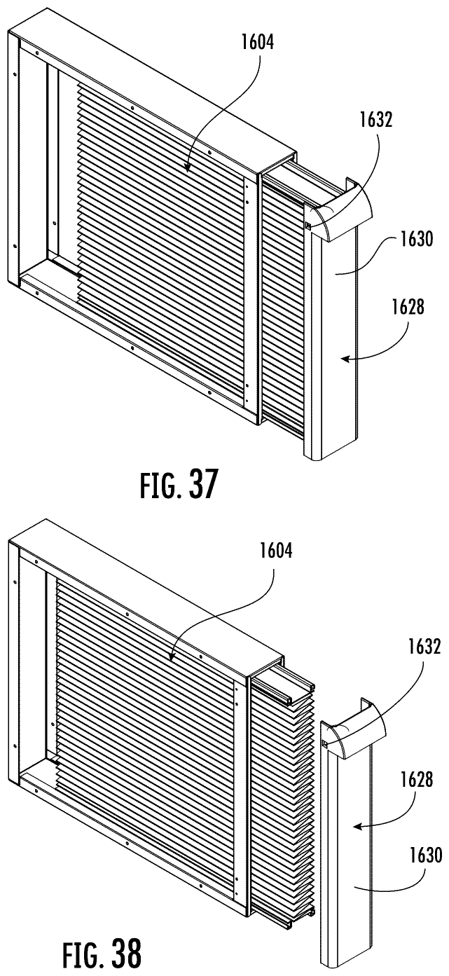

Referring to FIGS. 36-38, yet another example cover assembly 1628 of an air filter housing is shown. The cover assembly 1628 is configured to directly couple to a filter element 1604 to facilitate installation, and removal of the filter element 1604 from the air filter housing. The cover assembly 1628 includes a cover 1630 and a filter interface element 1632 that is coupled to the cover 1630.

The filter interface element 1632 is configured to detachably couple the cover 1630 to a filter element 1604. In the embodiment of FIGS. 36-38, the filter interface element 1632 is configured to detachably couple the cover 1630 to a longitudinal end of the filter element 1604. In some embodiments, the filter interface element 1632 includes a snap-fit connector that is configured to detachably couple the cover 1630 to a frame element of the filter element 1604. The snap-fit connector may include spring clips that engage slots defined by one or both frame elements at upper and lower ends of the filter media pack. In other embodiments, the snap-fit connector includes at least one pocket that is configured to receive a pair of flexible clips of the filter frame element(s). In yet other embodiments, the cover 1630 defines a channel that is narrower than the frame element(s) to thereby form a friction fit with the frame element(s) when the filter element is pressed into the channel. In yet other embodiments, the cover assembly 1628 and/or the frame element(s) include another type of fastening mechanism to couple the cover assembly 1628 to the filter element. Among other benefits, coupling the filter element 1604 to the cover assembly 1628 can simplify filter element installation and removal operations by eliminating the need to pull the filter element 1604 out of the enclosure as a separate piece from the cover assembly 1628.

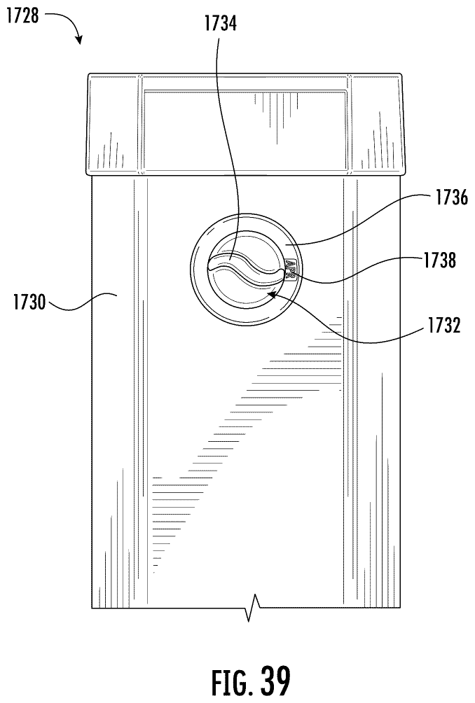

The cover assembly may include other interface features that simplify tracking and/or monitoring of filter element service life (e.g., an amount of dust loading and/or restriction across the filter element). For example, FIG. 39 shows an embodiment of a cover assembly 1728 of an air filter housing that includes a cover 1730 and a filter change indicator dial 1732 coupled to the cover 1730. The filter change indicator dial 1732 may include a knob 1734 or other actuator that is rotatably coupled to the cover 1730. In the embodiment of FIG. 39, the knob 1734 is fixedly coupled to an indicator panel that extends in a circumferential direction along an outer perimeter of the knob 1734. An outer ring portion 1736 of the filter change indicator dial 1732 is fixedly coupled to the cover 1730 so that the knob 1734 rotates relative to the outer ring portion 1736.

The outer ring portion 1736 of the filter change indicator dial 1732 includes a window 1738 (e.g., an opening, a slot, etc.) through which a user can view a portion of the indicator panel. In at least one embodiment, the indicator panel includes a listing of months in a year. In such an arrangement, a user or technical can rotate the dial to specify the month at which the filter element will need to be replaced (e.g., April as shown in FIG. 39). In another embodiment, the filter change indicator dial 1732 includes a timed movement dial (e.g., a spring-loaded mechanical timer) that could be set to the desired duration of filter life. For example, when a new filter is installed, a user can turn or otherwise adjust the timed movement dial to a 6 month change interval. During operation, the timed movement dial slowly rotates from a set position to an end position that indicates to a user that a filter change is required. In this way, the filter change indicator dial 1732 provides a conveniently located visual indicator of filter service life that can be quickly and easily adjusted when the filter element is replaced.

The air filter assembly may also include interface features that are configured to support a filter element within an air filter housing. For example, the air filter housing may include at least one filter-interface element that is configured to facilitate installation, and removal of a filter element of the air filter assembly. In other embodiments, the filter element may include frame elements (e.g., an endplate, a side cap, etc.) that is configured to support the filter element in position within the air filter housing.

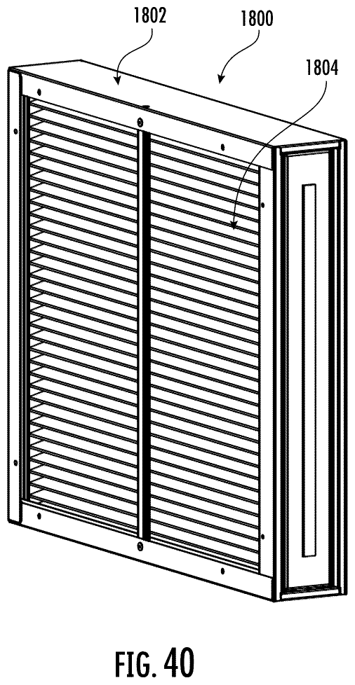

Referring to FIGS. 40-42, an air filter assembly 1800 is shown that includes a filter element 1804 that is configured to support itself in an expanded position within an air filter housing 1802. The filter element 1804 includes a filter media pack 1842 and a pair of frame elements (e.g., frame members, side caps, etc.) coupled to the filter media pack 1842.

The filter media pack 1842 is coupled to and extends between the first frame element 1844 and the second frame element 1846. The filter media pack 1842 is formed from a pleated filter media 1848. The filter media pack 1842 may include a collapsible extended surface pleated media (CESPM) filter that is shipped to an end user in a collapsed position (e.g., a collapsed state, a first position, etc.) in which the pleats of the filter media pack 228 are pressed together (e.g., under the weight of gravity) and/or collapsed onto one another (e.g., in which the first support element and the second support element are spaced apart by a first distance along an expansion direction of the filter media pack 1842, and/or are contacting one another), and an expanded position (e.g., an expanded state, a second position, etc.) in which the filter media pack is pulled apart to increase the average pleat angle between adjacent pleats across the media pack (e.g., in which the first support element and the second support element are separated by a second distance along the expansion direction that is greater than in the first distance). In the collapsed position, the pleats of the filter media are pressed together (e.g., under the weight of gravity, collapsed together, etc.) to reduce the overall package size of the filter element 1804. The filter media pack 1842 is expanded by a user prior to installation in the filter housing 1802. The filter element 1804 may be expanded by separating opposing filter frame elements to expose channels between pleats of the filter media 1848. The filter media 1848 may be a fibrous filter media made from a mat of synthetic fibers. In other embodiments, the filter media 1848 is made from another filter media material including, but not limited to, synthetic fiber non-woven sheets, glass fiber non-woven sheets, combined synthetic and glass fiber non-woven sheets, natural fiber non-woven sheets, or combinations thereof. In other embodiments, the filter media 1848 is made from another type of filtration material.

The filter media pack 1842 includes filter media 1848 that is pleated or folded back onto itself in an accordion pattern/shape. The filter media 1848 is folded along a first plurality of bend lines and a second plurality of bend lines. The first plurality of bend lines and the second plurality of bend lines extend linearly along the filter media 1848 and are oriented substantially parallel to one another. The second plurality of bend lines is disposed in alternating arrangement with the first plurality of bend lines. The first plurality of bend lines and the second plurality of bend lines are spaced in approximately equal intervals across a surface of the filter media 1848.

The filter media pack 1842 includes substantially linear wall segments of filter media extending between adjacent ones of the first plurality of bend lines and the second plurality of bend lines. The plurality of wall segments together define a plurality of channels that each extend between longitudinal ends (e.g., horizontally as shown in FIG. 40) of the filter media 1848. The channels define “V” shaped openings at longitudinal ends of the filter media pack 1842.

The first frame element 1844 and the second frame element 1846 are configured to support the filter media pack 1842 in an expanded position within the air filter housing 1802. In the embodiment of FIGS. 40-43, the first frame element 1844 and the second frame element 1846 are side caps that are engaged with and coupled to opposing longitudinal ends of the filter media pack 1842.

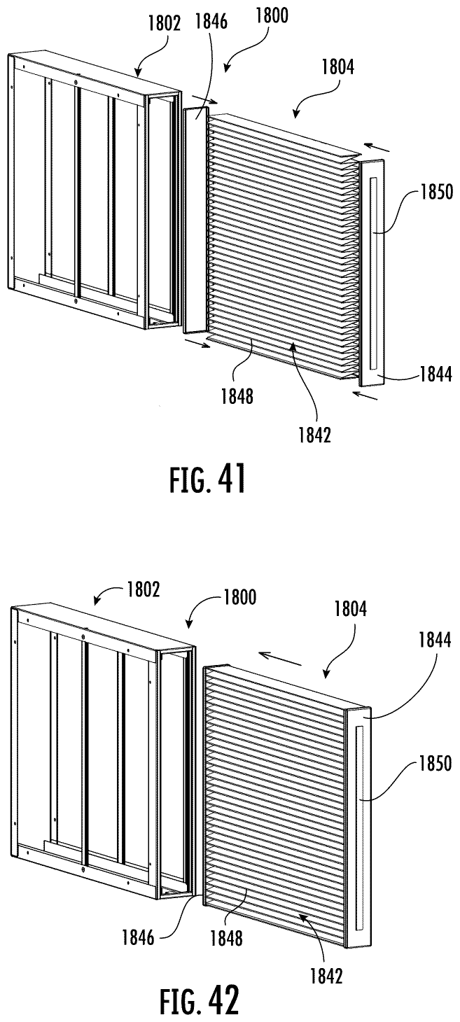

The first frame element 1844 has the same design as the second frame element 1846, which can simplify manufacturing of the filter element assembly. In other embodiments, the design of the first frame element 1844 and the second frame element 1846 are different. As shown in FIG. 41, the first frame element 1844 includes a cup-shaped panel defining a recessed area that is configured to receive a longitudinal end of the filter media pack 1842 therein. In some embodiments, the first frame element 1844 includes (e.g., defines) a clip element that is configured to snap onto endcaps that are bonded or otherwise coupled to end pleats of the filter media pack 1842 to support the filter media pack 1842 in the expanded position. In other embodiments, the first frame element 1844 may be bonded to the filter media pack 1842 using glue, epoxy, or another adhesive product.

The first frame element 1844 includes a seal member 1850 that is incorporated into or otherwise coupled to the first frame element 1844. The seal member 1850 may be a non-porous foam material, insulation, magnetic weather stripping, or another type of gasket material. The seal member 1850 extends in a transverse direction along the first frame element 1844 between opposing ends of the first frame element 1844 (e.g., between upper and lower ends, transverse ends, etc.). The seal member 1850 is configured to sealingly engage one of the enclosure sidewall or the cover of the air filter housing 1802 to prevent air leakage therebetween.

In some embodiments, the seal member 1850 is bonded to the first frame element 1844 and the second frame element 1846 using glue, epoxy, double-sided tape, or another type of adhesive material. In other embodiments, the seal member 1850 is overmolded onto the first frame element 1844 and/or the second frame element 1846.

As shown in FIGS. 41-42, a method of installing the filter element into the air filter housing includes expanding the filter media pack and coupling the first and second frame elements to the filter media pack on opposing longitudinal ends of the filter media pack. The method may include engaging at least one tab of an endcap that is coupled to the filter media pack to a slot, clip, or retainer in the first and second frame elements to thereby support the filter media pack in the expanded position. The method may further include inserting the filter element into the air filter housing, through the access opening at the longitudinal end of the air filter housing and to sealingly engage a seal member of the first frame element with a longitudinal sidewall of the air filter housing. The method may include sealingly engaging a second seal member of the second frame element with an inner surface of the cover assembly. In other embodiments, the method may include additional, fewer, and/or different operations.

In at least one embodiment, the air filter assembly (e.g., the air filter housing) includes a rail system to couple the filter element to the air filter housing and to support the filter element in an expanded position with the air filter housing.

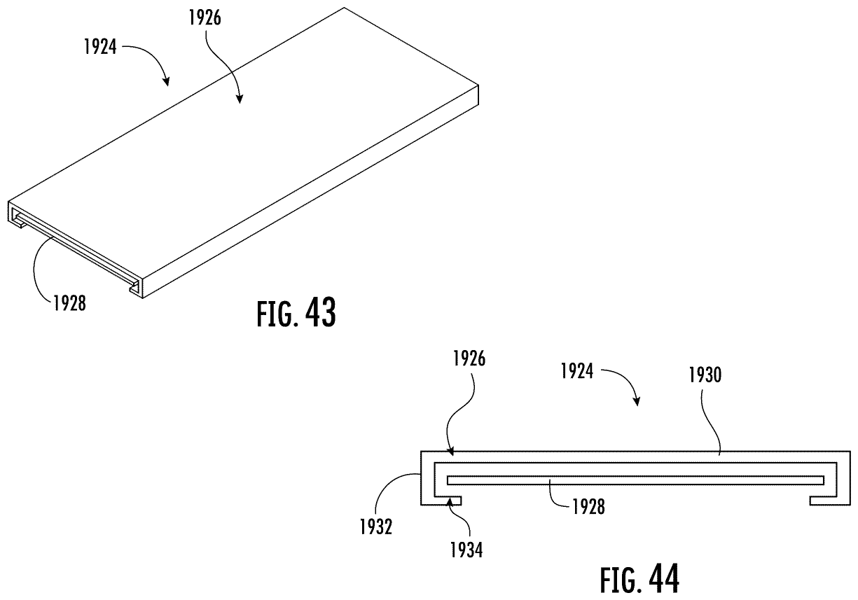

Referring to FIGS. 43-44, a rail system 1924 for an air filter housing is shown, according to an embodiment. The rail system 1924 includes a rail member 1926 and a frame element 1928. The rail member 1926 (e.g., a rail element, a rail guide, etc.) is configured to be coupled to an enclosure of an air filter housing, such along an upper sidewall (e.g., a longitudinally extending sidewall) within an interior cavity of an air filter housing. In some embodiments, the rail member 1926 is formed separately from the enclosure of the air filter housing and is fastened, welded, or otherwise coupled to the sidewall(s) of the enclosure. In other embodiments, the rail member 1926 is integrally formed with the enclosure (e.g., with the upper sidewall, etc.) as a monolithic structure (e.g., a unitary body, etc.) from a single piece of material.

The rail member 1926 is an elongated member having a base wall 1930 and a pair of rail sidewalls 1932 (e.g., rail flanges, etc.) extending along opposing edges of the base wall 1930. Each of the rail sidewalls 1932 extends away from the base wall 1930 in a substantially perpendicular orientation relative to the base wall 1930. The rail sidewalls 1932 each include a ledge at a distal end of the rail sidewalls 1932 that extends substantially parallel to the base wall 1930, toward a central axis of the base wall 1930. Together, the base wall 1930 and the pair of rail sidewalls 1932 define a rectangular-shaped channel 1934 that is configured to receive a frame element of a filter element therein.

The frame element 1928 includes a planar endcap of the filter element. In the embodiment of FIGS. 43-44, the frame element 1928 is a rectangular plate having a width that is less than a width of the rectangular-shaped channel 1934 but is greater than a gap formed between the ledges of the pair of rail sidewalls 1932. In the embodiment of FIG. 44, the frame element 1928 is slidably engaged with the rail member 1926 along a longitudinal direction (into and out of the page in FIG. 44). The pair of rail sidewalls 1932 circumscribes lateral ends of the frame element 1928 to support the frame element within the air filter housing. In some embodiments, an end of the rail member 1926 and/or the frame element 1928 is chamfered or includes another form of lead-in (a rounded lead-in along an entry region to the channel in the rail member 1926) to facilitate alignment between the frame element 1928 and the channel in the rail member 1926. Among other benefits, the planar frame element and rail member design of FIGS. 43-44 can be stamped, molded, or otherwise formed from a single piece of material, and may only require a small number of processing operations, which can reduce manufacturing complexity and cost.

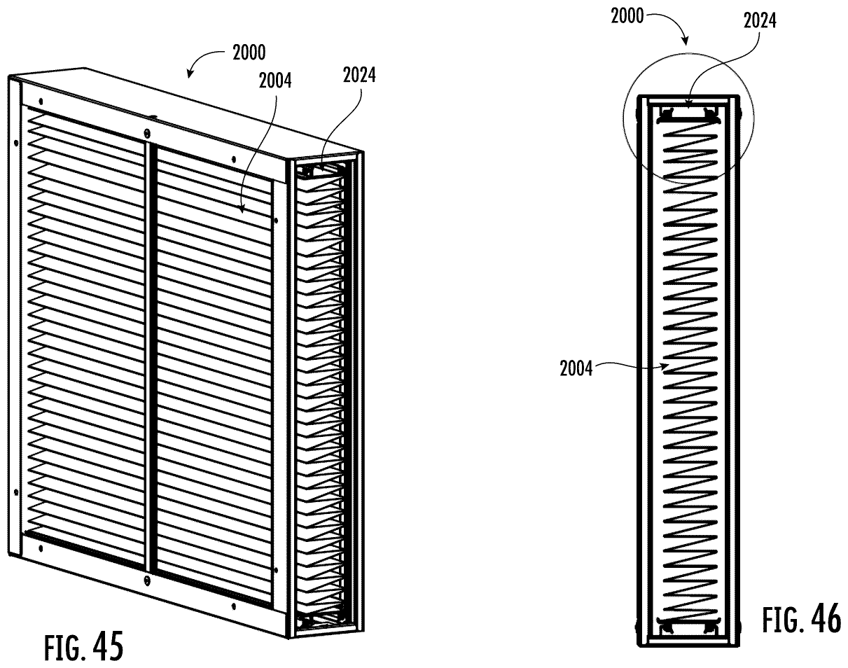

It should be understood that the design of the rail system may be different in various embodiments. For example, referring to FIGS. 45-48, another exemplary rail system 2024 for an air filter assembly 2000 is shown. The rail system 2024 includes rail members 2026 at both an upper end (e.g., a first transverse end, a first vertical end, etc.) and a lower end (e.g., a second transverse end, a second vertical end, etc.) of an enclosure of an air filter housing. The rail system 2024 is configured to slidably engage opposing ends of a filter element 2004 and support the filter element 2004 in an expanded position within the air filter housing.

As shown in FIG. 48, during installation of the filter element 2004 into the filter housing, a user inserts a longitudinal end of the filter element into the access opening, engaging the first frame element 2028 of the filter element 2004 and a second frame element 2029 of the filter element 2004 with the rail members 2026 (e.g., a frame support, etc.) within the filter housing, which secures the filter element 2004 within the interior cavity. Referring to FIG. 45-46, the rail members 2026 define track(s) that extends along an upper or lower sidewall of the housing 202 along a longitudinal direction between opposing longitudinal ends of the housing 202.

The rail members 2026 may include ridges or another filter frame interface that engages with corresponding features of the frame elements to maintain alignment between the filter element 2004 and the air filter housing, and to guide insertion of the filter element 2004 along the longitudinal direction into the interior cavity.

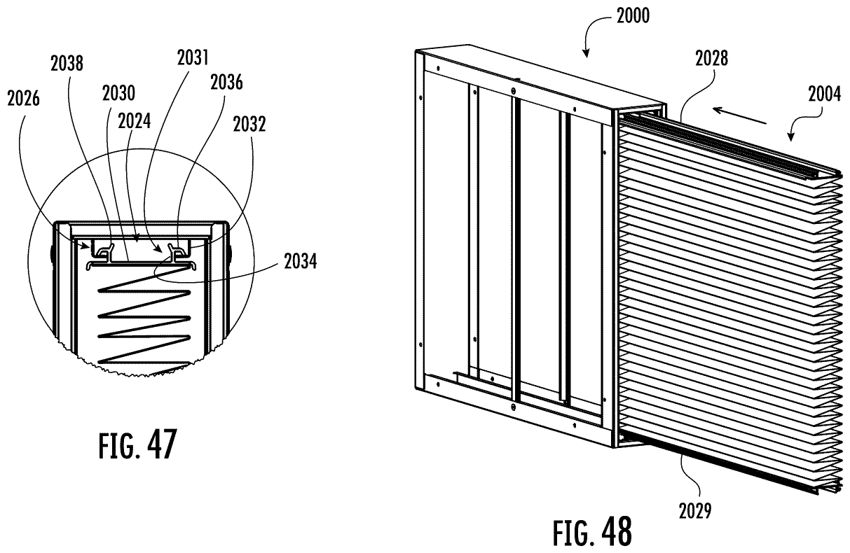

Referring to FIG. 47, the rail members 2026 may be similar or identical to the rail member described with respect to FIGS. 43-44. Each rail member 2026 may include a pair of rail sidewalls 2032 forming a rectangular-shaped channel therebetween that extends along an entire length of the rail member 2026.

The frame elements 2028 (e.g., endcaps, endplates, frame members, support members, support elements, etc.) are configured to slidably engage with the rail members 2026 to allow movement therebetween along the longitudinal direction. In the embodiment of FIG. 47, each frame element 2028 includes an endcap base wall 2030 and a rail interface element 2031. The rail interface element 2031 is configured to couple the endcap base wall 2030 to a respective one of the rail members 2026. The rail interface element 2031 includes a pair of rail inserts 2034 (e.g., a pair of clip member portions, a pair of clip members, a pair of feet, etc.) that are arranged symmetrically about a central axis of the endcap base wall 2030. The rail inserts 2034 are offset from the lateral ends of the endcap base wall 2030 and extend along an entire length of the endcap base wall 2030 in the longitudinal direction.

The rail inserts 2034 may be formed in a variety of shapes to facilitate coupling between the frame element 2028 and the rail member 2026. In the embodiment of FIG. 47, each rail insert 2034 includes a hooked portion 2036 that faces outwardly toward the lateral ends of the endcap base wall 2030 (the left and right ends of the endcap base wall 2030 as shown in FIG. 47). The hooked portion 2036 is spaced apart from the endcap base wall 2030 by a gap. Each rail insert 2034 also includes an endcap ridge 2038 extending away from the hooked portion 2036 and the endcap base wall 2030. In the embodiment of FIG. 47, the endcap ridge 2038 is angled away from the hooked portion 2036. Together, the hooked portion 2036 and the endcap ridge 2038 define an ‘r’ shaped profile. In some embodiments, a height of the rail inserts 2034 is approximately equal to a height of the channel defined by the rail member 2026. In some embodiments, the rail system 2024 is configured to sealingly engage the filter element 2004 with the air filter housing. For example, when engaged with the rail member 2026, the rail inserts 2034 and the rail member 2026 together define a tortuous path for airflow therethrough, which can prevent bypass of air through the interface between the rail inserts 2034 and the rail member 2026. The unique geometry of the rail inserts 2034 can also provide a convenient human interface and alignment feature to facilitate assembly operations.

Referring still to FIG. 48, a method of installing the filter element 2004 into the filter housing includes aligning the filter element 2004 with an opening of the filter housing. For example, the method may include aligning a longitudinal edge of the filter media pack with the access opening in the filter housing. The method may include engaging a frame element of the filter element 2004 with the rail member 2026 that extends longitudinally away from the access opening along an upper or lower sidewall of the filter housing. The method may include positioning a portion of the frame element (e.g., the rail inserts 2034) within a channel defined by the rail member 2026 to slidably couple the frame element to the rail member 2026. In some embodiments, the method includes aligning the rail inserts 2034 with the channel by pressing the rail inserts 2034 together, such as by pinching or otherwise pulling endcap ridges 2038 of the rail inserts 2034 toward one another to reduce a spacing between the rail inserts 2034. The method includes inserting the filter element 2004 into the interior cavity by sliding the rail inserts 2034 along the rail member 2026.

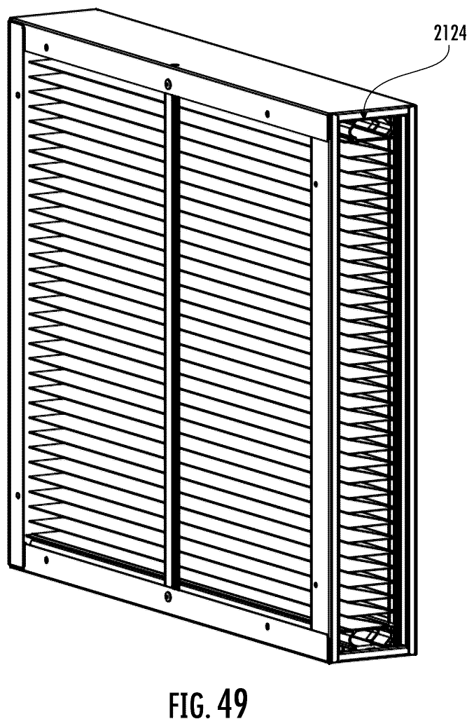

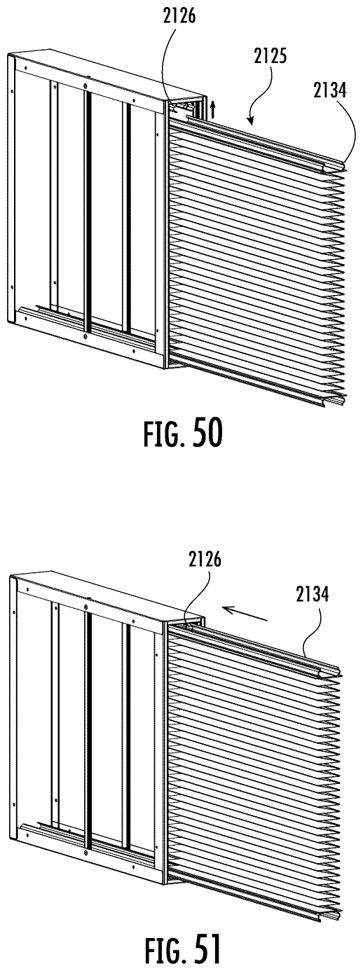

Referring to FIGS. 49-51, another example rail system 2124 for an air filter assembly is shown. The rail system 2124 includes a snap-fit interface 2125 that facilitates installation, and removal of the filter element from the air filter housing. The snap-fit interface 2125 also provides an audible indication of coupling between the filter element and a housing rail. As shown in FIG. 50, at least one frame element (e.g., endplate, endcap, frame member, support member, support element, etc.) of the filter element includes a first portion of the snap-fit interface 2125 in the form of a pair of rail inserts 2134 (e.g., clip members) that are curved or bowed so that a width between the pair of rail inserts 2134 is greatest at a midpoint along the height of the rail inserts 2134. Each of the rail inserts 2134 defines a convex surface facing inwardly toward one another. Each of the rail inserts 2134 also defines a concave surface on an outer lateral side of the rail inserts 2134. The rail inserts 2134 together define a clip member that is configured to clip (e.g., snap, etc.) or otherwise clasp onto or couple to the rail member 2126 (e.g., the housing rail, etc.) along a first direction (e.g., a transverse direction, an axial direction, an expansion direction of the filter media pack, etc.) to slidably engage the frame element to the rail member 2126 along a second direction (e.g., a longitudinal direction, etc.) that is substantially perpendicular to the first direction.

The rail member 2126 has a shape that corresponds with the shape of the rail inserts 2134. In some embodiments, the rail inserts 2134 and/or the rail member 2126 include a cylindrical bead at a distal end that facilitates engagement between the rail inserts 2134 and the rail member 2126. In some embodiments, the location of the rail member 2126 and the rail inserts 2134 are reversed (so that the rail member 2126 is disposed on the frame element instead of on the housing rail).

As shown in FIGS. 50-51, a method of installing the rail inserts 2134 into the rail member 2126 includes pressing the frame element upwardly against the rail member 2126 along the first direction. Such an operation may be performed with a leading edge of the filter element (e.g., the frame element) inserted into the filter housing, or with substantially the entire filter element inserted into the filter housing. For example, the method may include inserting the filter element in a collapsed position into the filter housing. The method may include expanding the filter element, for example, by lifting one of the frame elements away from the other frame element (e.g., under the force of gravity, etc.), and pressing the lifted frame element into the rail member 2126. The upward force (or downward force depending on which frame element is being engaged with the rail member 2126) causes the rail inserts 2134 to bend or otherwise deform away from one another (or toward one another in other embodiments) and to nestably engage the rail member 2126 in a snap-fit arrangement. In some embodiments, the rail member 2126 is received within a channel defined by the rail inserts 2134. In other embodiments, the rail inserts 2134 are received within a channel defined by the rail member 2126. In embodiments in which only a leading edge/end of the frame element is engaged with the rail member 2126, the method may further include pressing the filter element into the filter housing so that the rail inserts 2134 slide relative to the rail member 2126 to fully position the filter element within the filter housing.

The design of the rail system shown in FIGS. 50-51, and other “snap-fit” embodiments described herein also enables an end-to-end engagement of the rail inserts 2134 relative to the rail member 2126, without a snap or press-fit operation along the transverse or axial direction (e.g., without pressing the frame elements along an expansion direction of the filter element to engage the rail inserts 2134 with the housing rail). In such implementations, the method of installation may include aligning a longitudinal end of the rail inserts 2134 with a longitudinal end of the rail member 2126. The method may include pressing the rail inserts 2134 in the longitudinal direction into a gap, channel, or opening that is defined by the rail member 2126 to nestably engage the rail inserts 2134 with the rail member 2126. The method may include pressing the filter element along the longitudinal direction (e.g., sliding the frame element along the rail member 2126) to fully install the filter element within the filter housing. In other embodiments, the method may include a different order of operations (e.g., combination of snapping and sliding between the rail inserts 2134 and the rail member 2126, etc.).

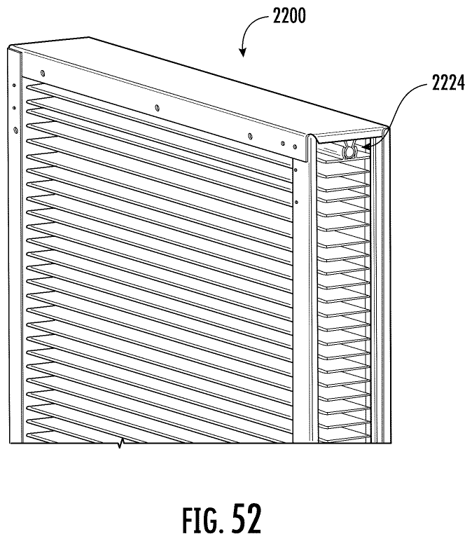

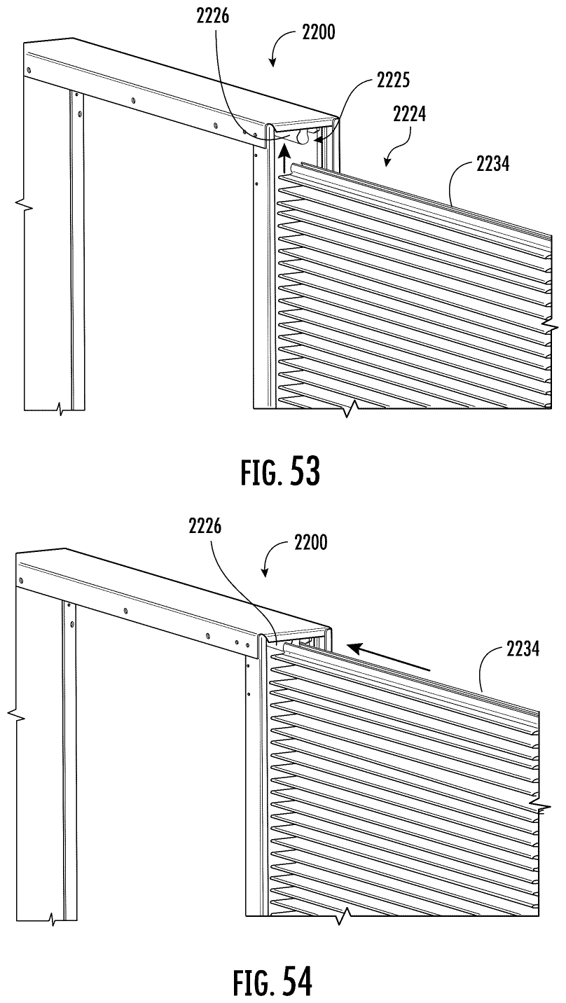

The design and arrangement of the snap-fit interface may be different in various embodiments. Referring to FIGS. 52-54, another example rail system 2224 for an air filter assembly 2200 is shown that includes a snap-fit interface 2225. The snap-fit interface 2225 has a similar design as the snap-fit interface described with respect to FIGS. 49-51. However, a width of the channel formed between a pair of rail inserts 2234 is less than that used in the design of FIGS. 49-51. As shown in FIG. 53, the rail member 2226 has a rounded outer end defining a club shape of approximately constant outer radius when viewed normal to the access opening.

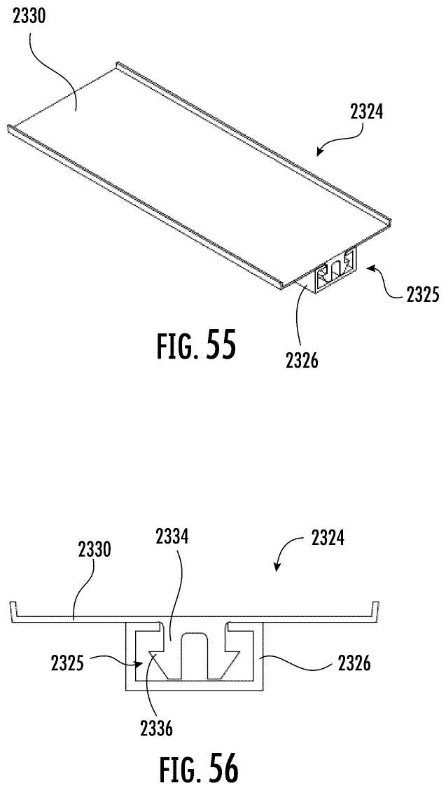

Referring to FIGS. 55-56, another example rail system 2324 that includes a snap-fit interface 2325 is shown. Each one of a pair of rail inserts 2334 of the frame element defines a barb 2336 having a tapered outer surface that faces outwardly toward an outer edge of the endcap base wall 2330. Together, the rail inserts 2334 define a clip member that is insertable into a gap/slot defined by the rail member 2326 and to clip/snap into a rectangular channel defined by the rail member 2326. Among other benefits, the barbed interface between the rail inserts 2334 and the rail member 2326 prevent the frame element from inadvertently separating and/or pulling away from the rail member 2326 after installation.

It should be understood that the rail inserts 2334 may have various other shapes and arrangement in other embodiments to enable securing the frame element to a housing rail (e.g., to enable a snap-fit or press fit arrangement between the frame element and the housing rail). In some embodiments, a similar or identical structure to the rail inserts 2334 as described with respect to any of the embodiments disclosed herein could be defined by the housing rail (e.g., rail member) and vice versa. In other embodiments, the frame element includes a rail insert (e.g., a protrusion, etc.) formed from a compliant material such as rubber, urethane, or soft plastic to enable securing the frame element to the rail insert via a press-fit arrangement in which the rail insert is held in the rail by the force exerted on the rail by the compliant material.

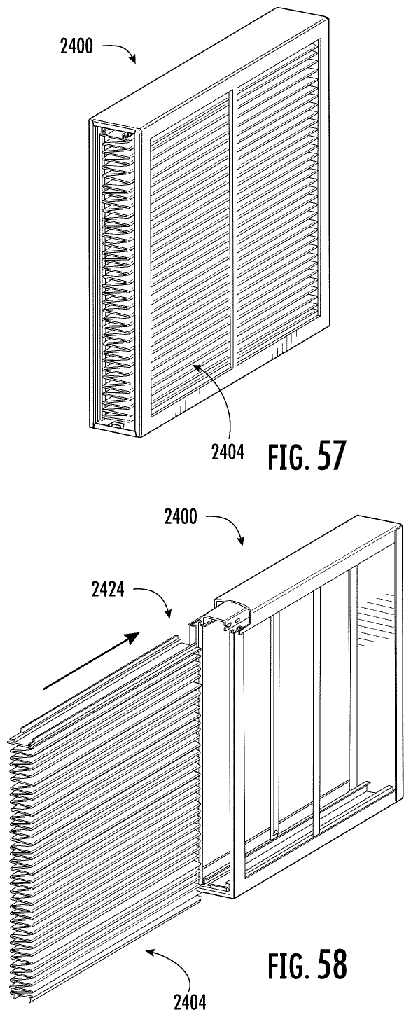

Referring to FIGS. 57-60, another example rail system 2424 for an air filter assembly 2400 is shown. The rail system 2424 is configured to provide an audible and/or tactile indication to a user when the filter element is fully installed into the air filter housing. As shown in FIG. 58, a filter element 2404 of the air filter assembly 2400 includes a frame element having rail inserts 2434 that are configured to slidably engage a rail member 2426 on the air filter housing. At least one of the rail inserts 2434 defines a notch 2436 (e.g., an opening, a slot, a window, etc.) at a longitudinal end of the rail insert 2434. The notch 2436 extends in a longitudinal direction along a distal end of the rail insert 2434 (e.g., an outermost end of the rail insert 2434).

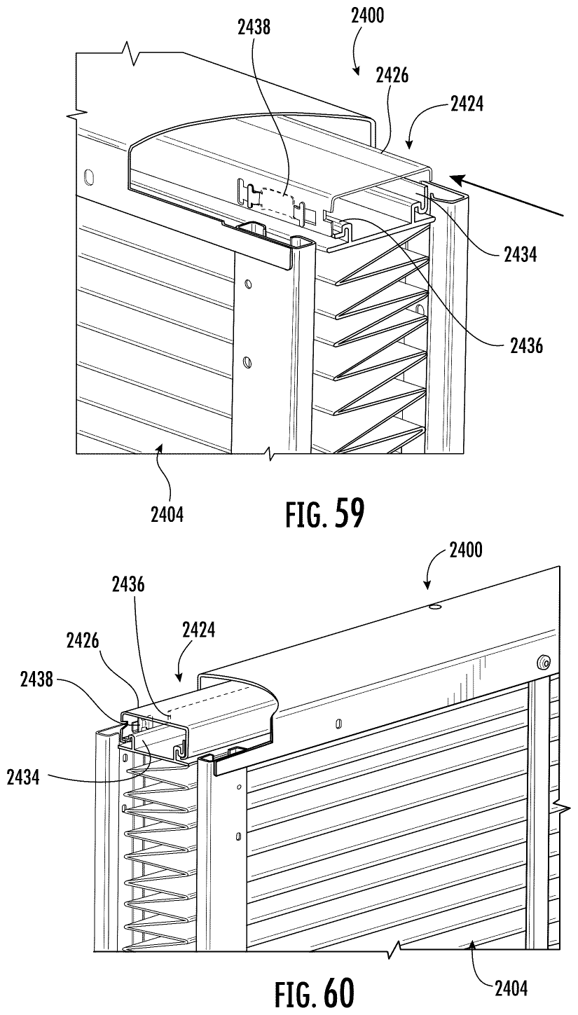

Referring to FIGS. 59-60, the rail system 2424 includes a clip member 2438 (e.g., a clip element, a snap clip, etc.) coupled to the rail member 2426 proximate to a longitudinal end of the rail member 2426. The clip member 2438 may be a spring clip that is slotted into or otherwise coupled to the rail member 2426. During assembly, the rail insert 2434 engages the clip member 2438 and presses the clip member 2438 against the rail member 2426. The clip member 2438 engages (e.g., clicks into) the notch 2436 when the filter element 2404 is fully installed into the air filter housing to thereby provide audible feedback to the user that the filter element has been fully seated into the air filter housing. In some embodiments, the clip member 2438 can also help retain the filter element 2404 within the air filter housing.

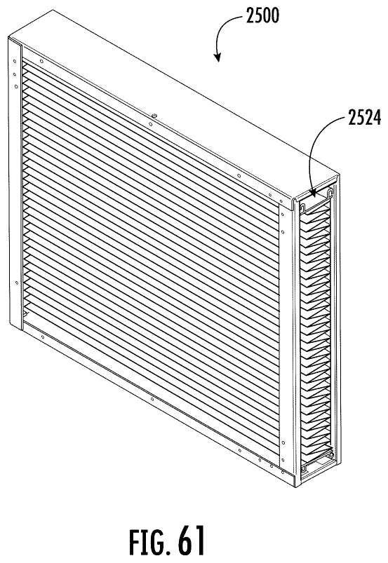

Referring to FIGS. 61-63, yet another example rail system 2524 for an air filter assembly 2500 is shown. The rail system 2524 includes a rail member 2526 coupled to the air filter housing and a frame element 2528 coupled to the filter media pack. The frame element 2528 includes rail inserts 2534 that are configured to slidably engage the rail member 2526 so that the filter element can move relative to the air filter housing along the longitudinal direction.

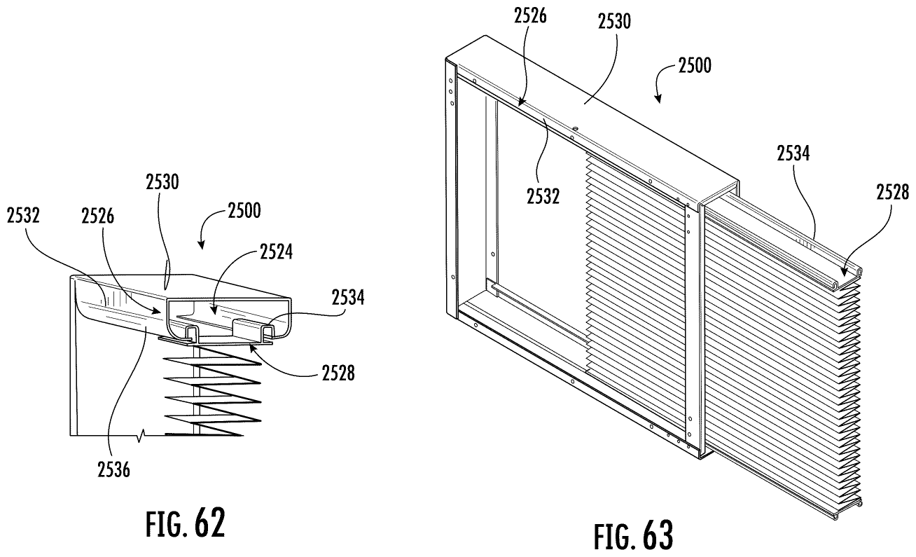

As shown in FIG. 62, the rail member 2526 is integrally formed with an upper sidewall of the air filter housing as a monolithic piece from a single piece of material. Such an arrangement can reduce manufacturing complexity and the number of components used in the air filter assembly 2500. The rail member 2526 includes a base wall 2530 (e.g., a planar portion of the upper sidewall) and a pair of rail sidewalls 2532 (e.g., rail flanges, etc.) extending along opposing edges of the base wall 2530. Each of the rail sidewalls 2532 extends away from the base wall 2530 in a substantially perpendicular orientation relative to the base wall 2530. The rail sidewalls 2532 each include an arcuate ledge 2536 that curves inwardly toward a central axis of the base wall 2530. The rail sidewalls 2532 may also include an intermediate section that extends between the base wall 2530 and the arcuate ledge 2536 and that is oriented normal to the base wall 2530. In other embodiments, the arcuate ledge 2536 may extend from the base wall 2530.

A distal end of the arcuate ledge 2536 extends substantially parallel to the base wall 2530. Among other benefits, the rounded shape of the arcuate ledge 2536 at both the inlet and outlet of the air filter housing forms a smooth transition/entry region for air flow entering and leaving the air filter housing, which can reduce flow separation and improve air flow through the filter element.

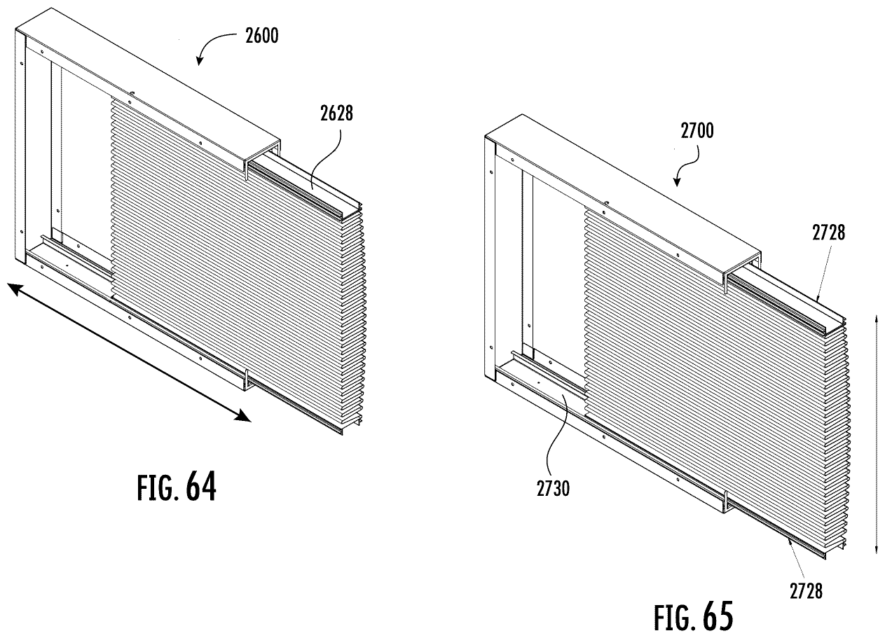

In some embodiments, the rail system includes a magnetic material to facilitate installation of the filter element into the air filter housing. For example, referring to FIGS. 64, a filter assembly 2600 is shown that is configured to use a magnetic material to provide a tactile indication to a user that the filter element has been fully seated within the air filter housing. The filter element includes a magnetic material embedded or otherwise coupled to at least one frame element 2528 at a longitudinal end of the frame element 2528. The air filter housing includes a magnetic material coupled to a longitudinal end and/or sidewall of the air filter housing that is configured to interact with the magnetic material in the frame element 2528 during assembly. The force resulting from the interaction between the magnetic material on the frame element 2528 and the air filter housing provides a tactile indication to a user that the filter element is fully and correctly seated within the air filter housing. The force can also facilitate installation operations by reducing the force required to fully seat the filter element within the filter housing.

In some embodiments, the magnetic material on either end of the frame element 2528 is a ferromagnetic material (e.g., a metal including iron cobalt, nickel, etc.) that is configured to interact with a permanent magnet (e.g., a neodymium magnet or another type of permanent magnet made from “hard” ferromagnetic materials). In other arrangements, the magnetic materials used on the filter housing and the frame element may be reversed, or both may include a permanent magnet. Among other benefits, including a permanent magnet on only the air filter housing can reduce the cost of the filter element.

Referring to FIG. 65, another example air filter assembly 2600 is shown in which magnetic materials are embedded or otherwise coupled to a frame element 2628 along an entire length of the frame element 2628, or a substantial portion thereof. The air filter housing may include rail members that are made from, or include, a permanent magnet that is configured to interact with the magnetic material along the frame element 2628 and to prevent the filter element from collapsing during operation. In some embodiments, the frame element 2628 is fully fused with a magnetic material, such as iron, iron alloy, or another type of magnetic material. In other embodiments, the magnetic material is a single or multiple discrete magnetic strips that are embedded or bonded to the frame element 2628.

As shown in FIG. 65, a method of installing the filter element into the air filter housing may include inserting the filter element in a collapsed or partially collapsed position into an interior cavity of the air filter housing. The method may include expanding the filter element by pulling at least one frame element 2628 toward a magnetic material in the rail member to magnetically couple the frame element 2628 to the air filter housing. The method may further include sliding the filter element to fully seat the filter element within the filter housing (as the force of friction between the frame element 2628 and the rail member may be less than the magnetic force pulling the frame element 2628 toward the rail member).

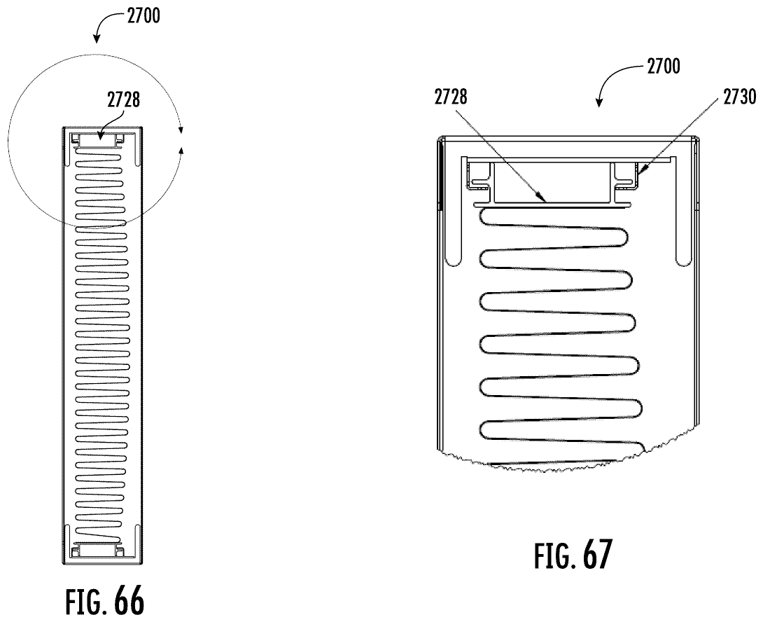

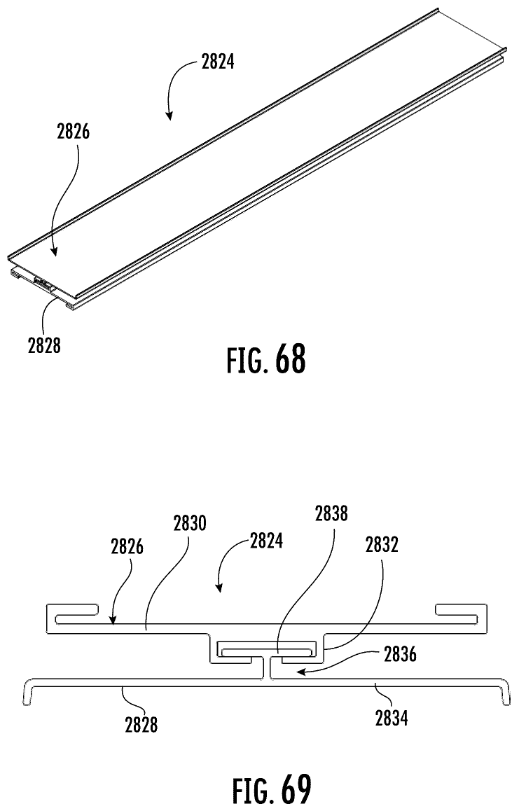

Referring to FIGS. 66-67, another example air filter assembly 2700 is shown that includes a magnetic interface between the filter element and the air filter housing. Like the frame element described in FIG. 65, the frame element 2728 in the embodiment of FIGS. 66-67 includes a magnetic material that is fused, embedded, or otherwise coupled to the frame element 2728 along a longitudinal extent of the frame element 2728. As shown in FIG. 67, a rail member 2730 also includes a magnetic material. In at least one embodiment, the rail member 2730 is made from the magnetic material. The rail member 2730 is polarized such that a magnetic field generated by the rail member 2730 is oriented opposite to a magnetic field orientation of the frame element 2728. When the frame element 2728 is inserted into a channel defined by the rail member 2730, a magnetic force acting between the frame element 2728 and the rail member 2730 acts to separate adjacent ledges (e.g., hooked portions, etc.) of the frame element 2728 and the rail member 2730, which can reduce the frictional force that prevents movement of the filter element along the longitudinal direction. Such an arrangement can allow nearly frictionless sliding which reduces the force required to insert the filter element into the air filter housing.

In some embodiments, features of the rail system may be incorporated into other components of the air filter assembly. For example, referring to FIG. 70, an air filter housing 2902 is shown that includes a cover assembly 2928 that is configured to support the air filter element within the air filter housing 2902. The cover assembly 2928 includes a cover 2930 (e.g., a cover base, a base panel, etc.) and at least one support shaft 2932. The cover 2930 is configured to engage an enclosure of the air filter housing at the access opening to close-off the access opening and to prevent air leakage through the access opening.

The at least one support shaft 2932 extends away from a planar inner surface of the cover 2930. In the embodiment of FIG. 70, the cover assembly 2928 includes a pair of support shafts 2932, including a first support shaft and a second support shaft that are disposed as opposing ends (e.g., opposing transverse ends) of the cover 2930. Each of the support shafts 2932 is configured to be inserted into an interior cavity of the housing and to engage a sidewall of the filter housing at an opposite end of the air filter housing as the cover assembly 2928. The sidewall of the air filter housing includes pockets 2933 and/or through-hold openings that are each configured to receive a distal end of a respective one of the support shafts 2932 therein.

In some embodiments, the support shafts 2932 are configured to slidably engage with rails (e.g., a rail member) that extends in the longitudinal direction between opposing ends of the air filter housing, to thereby guide the support shafts 2932 into the pockets 2933 disposed in a sidewall of the air filter housing.

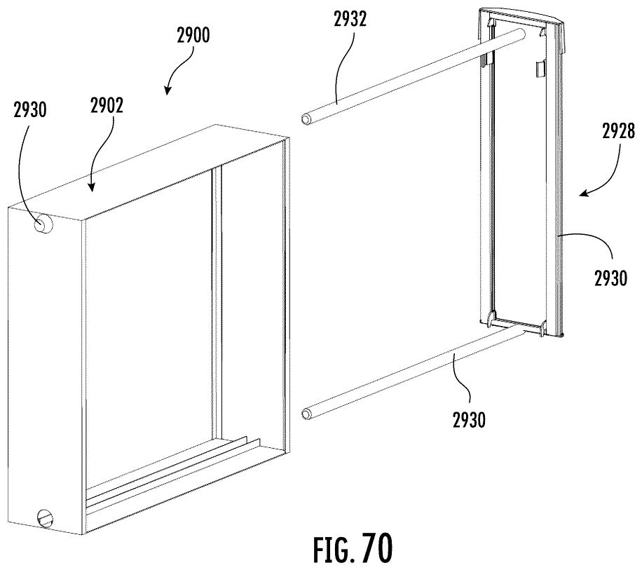

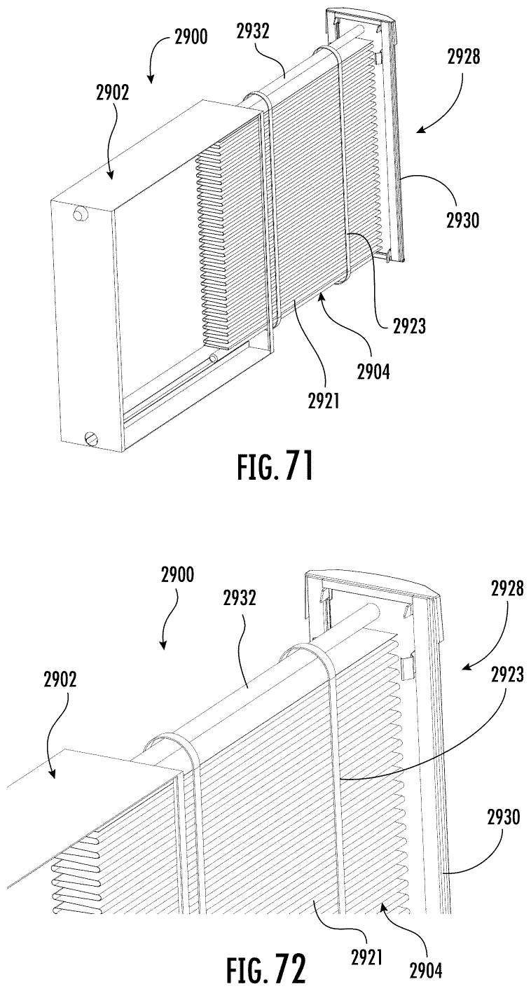

The support shafts 2932 are configured to couple the cover assembly 2928 to a filter media pack to support the filter media pack within the air filter housing. As shown in FIGS. 71-72, a filter element 2904 of the filter assembly 2900 includes the filter media pack 2921 and a plurality of media support elements 2923 that are coupled to the filter media pack 2921 and that prevent deformation (e.g., bowing, etc.) of the filter media pack 2921 under an applied pressure differential across the filter media pack 2921.

In the embodiment of FIGS. 71-72, the media support elements 2923 include a plurality of ribbons (e.g., support bands, etc.) that extend around the filter media pack 2921, around upper and lower ends of the filter media pack 2921. The plurality of ribbons may be sewed, bonded, or otherwise coupled to pleat tips of the filter media pack 2921 to ensure proper spacing between pleat tips when the filter media pack 2921 is in an expanded position.

The media support elements 2923 are configured to couple the filter media pack 2921 to the support shafts 2932. The media support elements 2923 include looped openings on either end of the filter media pack 2921 that are configured to receive the support shafts 2932 therein. The media support elements 2923 loop around the support shafts 2932 to maintain the filter media pack 2921 in the expanded position within the housing.

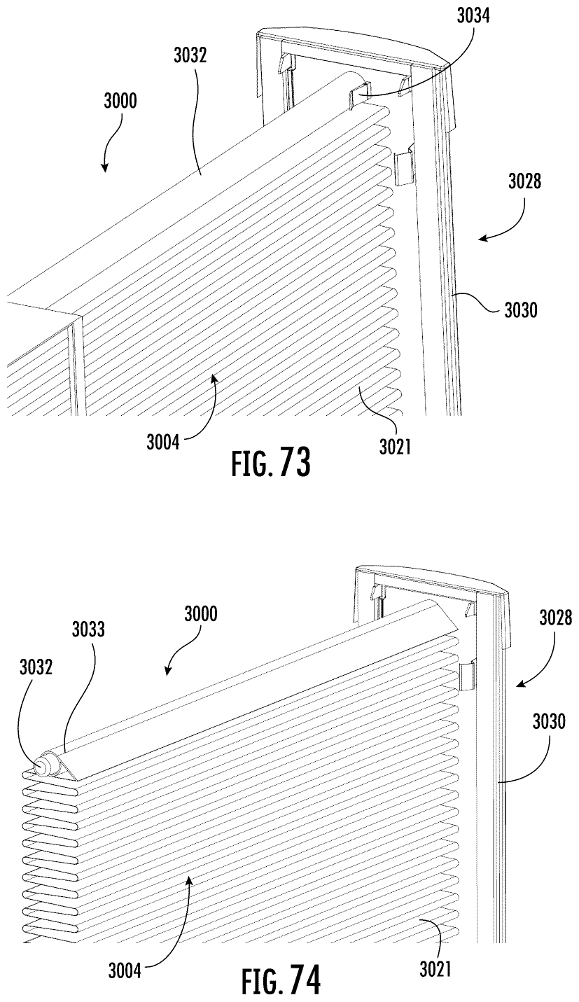

The interface between the filter element and the support shafts may be different in various embodiments. For example, referring to FIGS. 73-74, another example air filter assembly 3000 is shown that includes a cover assembly 3028 that is configured to support a filter element 3004 within an air filter housing. The cover assembly 3028 includes a cover 3030 and a plurality of support shafts 3032 (e.g., rods, dowels, etc.) extending away from the cover 3030. The cover assembly 3028 also includes at least one cover clip 3034 (e.g., at least one clip member, etc.) or other fastening member that is configured to prevent the filter media pack from moving along a longitudinal direction along the support shafts 3032. In the embodiment of FIG. 73, the cover clip 3034 includes a flexible extension (e.g., a tab clip, etc.) that engages the support shaft proximate to a distal end of the flexible extension.

The filter element 3004 includes a filter media pack 3021 having looped ends 3033 that extend along the end pleats of the filter media pack 3021. The looped ends 3033 include filter media that is looped back onto itself to form openings that extend along a longitudinal direction between opposing ends of the filter media pack 3021. The openings may be sized to receive a respective one of the support shafts 3032 therein. Among other benefits, incorporating the filter element into the cover assembly reduces the number of components required for the air filter assembly, and can simplify filter element installation and/or removal operations.

A method for installing the filter element into the air filter housing includes inserting a first looped end or media support member of the filter element through a first support shaft of the cover assembly. The method also includes expanding the filter media pack and engaging a second looped end or media support member of the filter element through a second support shaft of the cover assembly. The method may further include engaging at least one of the first looped end or the second looped end with at least one cover clip to pinch or otherwise retained the first looped end and/or the second looped end between the cover clip and the support shaft. The method may include inserting the cover assembly, including the integrated filter element, into an interior cavity of the air filter housing.

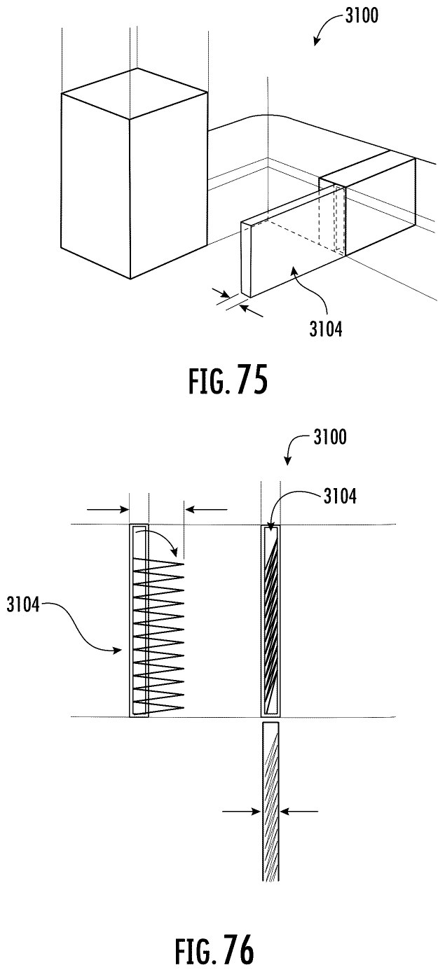

The arrangement of the filter element may also be different in various embodiments. For example, referring to FIGS. 75-76, an air filter assembly 3100 is shown that includes an expandable air filter element 3104. The filter element 3104 is repositionable between (i) a collapsed position in which the pleats of the filter element 3104 overlap one another, and (ii) an expanded position in which the pleats are rotated approximately 90° away from the collapsed position and parallel to a flow direction through the filter element. Among other benefits, such an arrangement increases an amount of filter media that can be used within the housing without increasing the size of the access opening.

In some embodiments, the filter element 3104 includes at least one media support element (e.g., a ribbon, etc.) that is configured to allow rotation of the filter media pack into the collapsed position and to support the filter media (e.g., pleat spacing, etc.) in the expanded position. The media support element may be longer on a first end of the filter media pack, such as at an upper end of the filter media pack. In such an arrangement, the weight of the filter media pack may be sufficient to cause the pleat to rotate downward (e.g., in a clockwise direction as shown in FIG. 76) and into the expanded position, similar to the operation of a venetian blind, after insertion into an air filter housing to increase the overall surface area (e.g., pleat depth along a flow direction through the filter element) of the filter media available for flow.

In some embodiments, the filter element 3104 is structured to expand from a first width of approximately 1 in. in the collapsed position to a second width of approximately 4 in. or greater in the expanded position. In other embodiments, the relative width of the filter element in the collapse and/or expanded positions may be different.

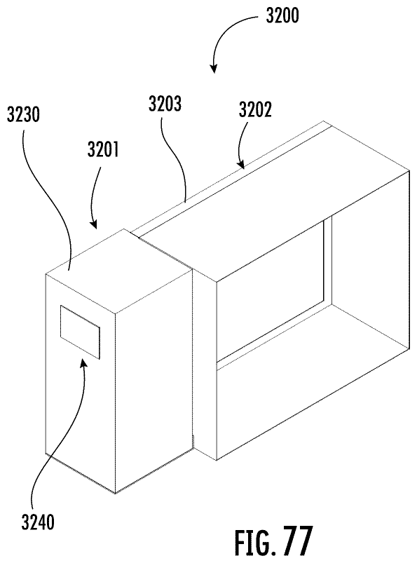

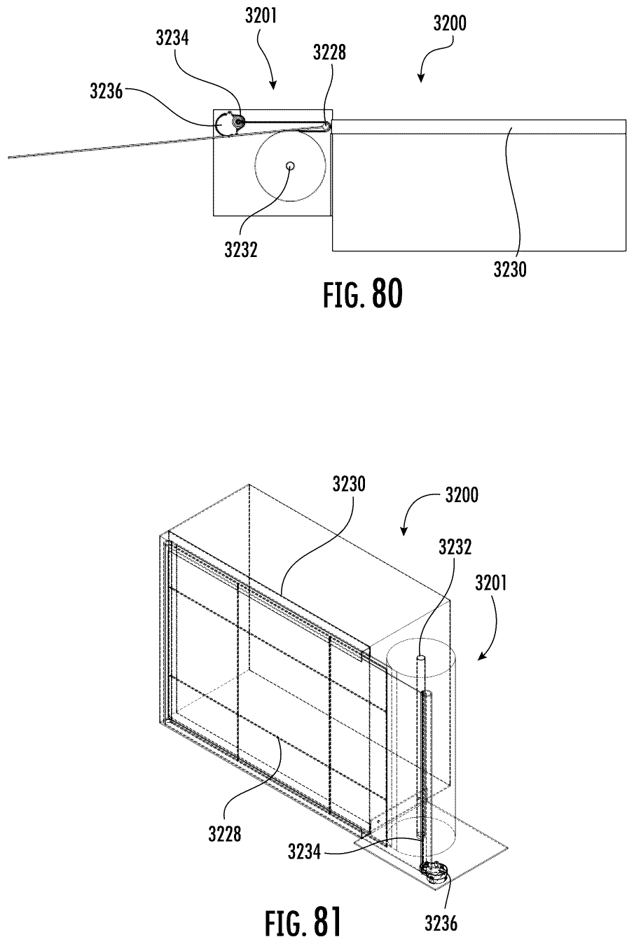

In some embodiments, the air filter assembly includes features that are configured to automatically load and/or reload filter media into an air filter housing. Referring to FIGS. 77-81, an air filter assembly 3200 that includes an automatic media feed system 3201 is shown, according to an embodiment. The air filter assembly 3200 also includes an air filter housing 3202 including a filter rack 3203 (e.g., a feed rack, a support frame, etc.) that is coupled to automatic media feed system 3201.

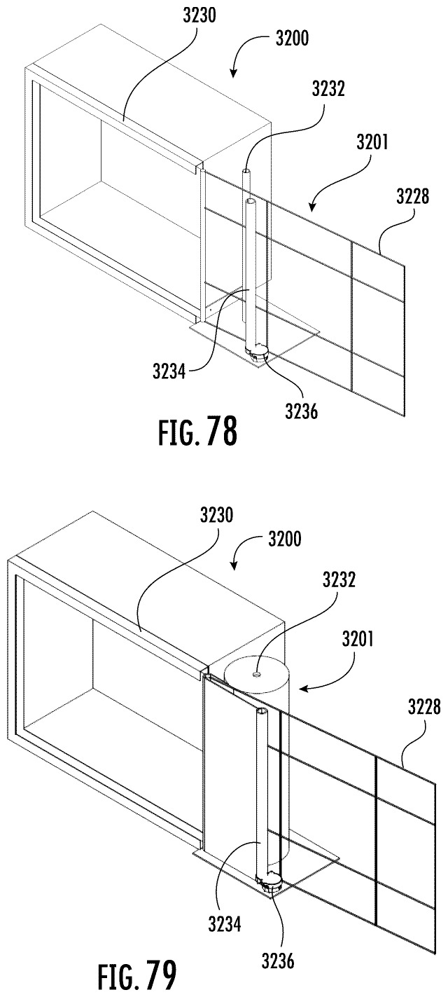

Referring to FIG. 77, the air filter housing 3202 includes a filter rack 3203 that is configured to couple the air filter assembly 3200 to ductwork or another HVAC component. As shown in FIGS. 78-79, the filter rack 3203 defines tracks that are configured to receive and guide a media support 3228 (and the filter media) into the air flow stream through the air filter housing 3202. In some embodiments, the tracks define a rectangular shaped channel that extends along an outer perimeter of a duct opening of the air filter housing. The channel extends along three sides of the outer perimeter of the duct opening to prevent the media support 3228 from being pushed past the duct opening.

The automatic media feed system 3201 includes a media housing 3230, a media holder 3232, a media driver 3234, a motor 3236, and the media support 3228. The media housing 3230 is configured to house various components of the automatic media feed system 3201 and to couple the automatic media feed system 3201 to the air filter housing 3202. As shown in FIG. 77, the media housing 3230 includes sidewalls defining a container that is configured to receive the media driver 3234, the motor 3236, and the media support 3228 therein. The media housing 3230 may also include a bracket that is configured to align and couple the media housing 3230 to the air filter housing 3202 and/or other HVAC components (e.g., a duct, a furnace, etc.).

The media holder 3232 is configured to couple a media roll to the automatic media feed system 3201. The media holder 3232 includes a media holder shaft that is coupled to a lower wall (e.g., base, etc.) of the media housing 3230. A media roll may be inserted over the media holder shaft to rotatably couple the media roll to the automatic media feed system 3201.

The media driver 3234 is configured to unroll or otherwise feed filter media from the media holder 3232. The media driver 3234 includes a hollow shaft that extends away from the lower wall of the media housing 3230 and is oriented substantially parallel to both the media holder 3232 and the filter rack 3203. In some embodiments, the hollow shaft includes a vertical slit (e.g., slot, opening, etc.) that is used to couple the filter media to the hollow shaft. The filter media may include a ‘T’ shaped edge along an outer end of the filter media that is insertable into the slit to couple the filter media to the hollow shaft. In other embodiments, the filter media may be bonded or otherwise coupled to the media driver 3234.

The motor 3236 is configured to power the media driver 3234 into rotation to unroll or otherwise feed filter media from the media holder 3232 (e.g., media roll) onto the media driver 3234. The motor 3236 is coupled to the lower wall of the media housing 3230 adjacent to a proximal end of the media driver 3234. In some embodiments, the media driver 3234 includes a gear at a proximal end of the media driver 3234 to couple the motor 3236 to the media driver 3234 so that the motor may rotate the media driver 3234.

The media support 3228 is configured to engage with the filter rack 3203 to support the filter media within the filter rack 3203 and across the duct opening. As shown in FIGS. 78-79, the media support 3228 includes a structural frame having cross-members that together define a rectangular panel. The cross-members define windows in the media support 3228 that allow airflow therethrough.

FIGS. 78-81 show a method of installing filter media using the automatic media feed system 3201. The method includes placing a media roll onto the media holder 3232 and connecting an end of the filter media to the media driver 3234. The method includes engaging the media support 3228 with the filter media by pressing the media support 3228 into a gap between the media holder 3232 and the media driver 3234. The method includes pressing or otherwise inserting the media support 3228 into channels defined by the filter rack 3203 to form a filter media panel for the air filter assembly, such that the media support 3228 is sandwiched or otherwise disposed between two layers of filter media. The method may also include securing the media support 3228 in place within the filter rack 3203 (e.g., by coupling the media support 3228 to the media housing 3230 and/or the filter rack 3203). As shown in FIG. 81, the method may include replenishing the filter media in the media panel by powering the media driver 3234 into rotation (e.g., using the motor 3236). Rotation of the media driver 3234 draws clean filter media from the media roll across the media support 3228.

In some embodiments, as shown in FIG. 77, the automatic media feed system 3201 includes a feed control system 3240 that is configured to control operation of the motor 3236 to continuously or periodically replenish the filter media within the air filter housing 3202. The feed control system 3240 includes at least one sensor, a user interface, and a control unit to control operation of various components of the automatic media feed system 3201.

The at least one sensor is configured to monitor conditions within the air filter housing. In one embodiment, the sensor is a pressure drop sensor that is configured to monitor pressure drop across the filter media. In another embodiment, the sensor is a flow rate sensor configure to monitor a flow rate of air through the air filter housing.

The user interface may be configured to display operating conditions of the air filter assembly. For example, the user interface may be configured to display measurements from one or more sensors. The user interface may also be configured to receive user inputs and control settings for the automatic feed system.

The control unit (e.g., a control circuit, etc.) is configured to coordinate data transfer between, and control of, the at least one sensor, the user interface, and/or the motor. In one embodiment, the control unit includes a process that is configured to receive and interpret data from the at least one sensor. The control unit may be configured to transmit control signal to the motor based on data from the at least one sensor. For example, the control unit may be configured to control the motor to replenish the filter media in response to data from the sensors, such as in response to data from the at least one sensor indicating that a pressure drop through the air filter housing exceeds a pressure drop threshold. In another embodiment, the control unit is configured to replenish filter media based on a media replenishment algorithm stored in memory of the control unit. In yet other embodiments, the control unit is configured to replenish filter media periodically or at a time-based replenishment rate.

Among other benefits, the automatic media feed system 3201 of FIGS. 77-81 can reduce the need for user interaction with the air filter assembly 3200, allowing for improved service life while maintaining pressure drop across the air filter assembly 3200 to within desired thresholds.

Referring to FIG. 82, a filter media pack design for use in an air filter assembly is shown, according to an embodiment. The filter media pack 3342 is structured to facilitate sealing between the filter media pack 3342 and an air filter housing. The filter media pack 3342 includes filter media that is pleated or otherwise formed back onto itself in an accordion shape. The filter media pack 3342 also includes a sealing material 3344 coupled to the filter media 3345 at each longitudinal end of the filter media 3345.

In some embodiments, the sealing material 3344 is adhered to the longitudinal ends of the filter media 3345. In other embodiments, the sealing material 3344 may be embedded or otherwise integrally formed with the filter media 3345. For example, the sealing material 3344 may include a soft foam or another soft and pliable synthetic material. In one embodiment, the sealing material 3344 is adhesively bonded to the filter media 3345. In another embodiment, the sealing material 3344 is ultrasonically welded to the outer edges of the filter media 3345, such as prior to a pleating operation to form a filter media pack, which can improve manufacturability as compared to coupling the sealing material 3344 to the filter media 3345 after pleating. In other embodiments, another bonding operation may be used to couple the sealing material 3344 to the filter media 3345. During use, the sealing material 3344 at each end of the filter media pack 3342 engages a sidewall of the air filter housing to sealingly engage the filter media pack 3342 with the air filter housing. By incorporating the sealing materials into the media pack, the number of independent seal members that are required in the air filter housing may be reduced, thereby reducing manufacturing cost and complexity. Such a design can also improve sealing performance across the filter element.

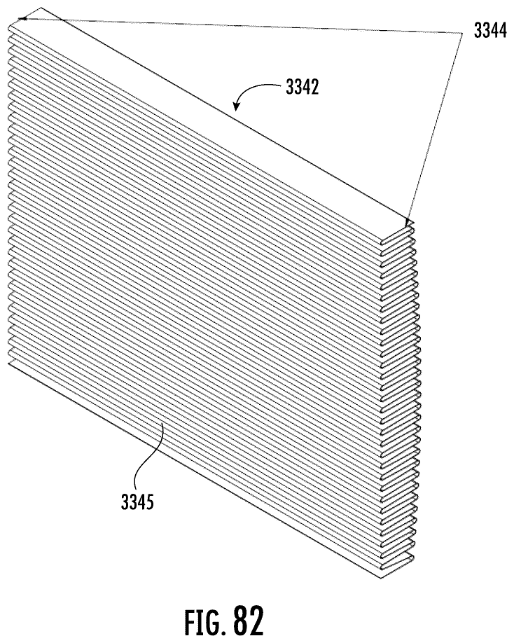

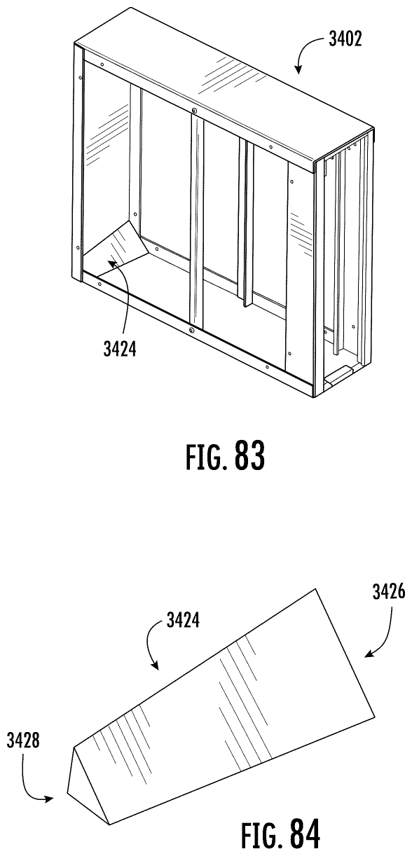

In some embodiments, the air filter assembly includes aerodynamic elements and/or features to improve air flow through the filter assembly. For example, referring to FIGS. 83-84, an air filter housing 3402 is shown that includes a flow element 3424 to reduce areas of flow separation and improve performance of the air filter assembly. The flow element 3424 (e.g., corner member, block, etc.) is configured to engage the air filter housing 3402 along a sidewall of the air filter housing 3402, in areas of the air filter housing 3402 experiencing low air flow velocity during operation of the HVAC system. In the embodiment of FIG. 83, the flow element 3424 is disposed in a corner region of the air filter housing (within the interior cavity) and blocks air flow to the corner region, which can reduce flow separation (e.g., eddy currents, etc.) across the air filter housing, thereby reducing pressure drop and improving flow performance.

In the embodiment of FIG. 84, the flow element 3424 is a single piece of material that has a generally triangular shaped cross section. The flow element 3424 is tapered along two edges between a first end 3426 and a second end 3428 of the flow element 3424, so that a cross-sectional area of the flow element 3424 decreases along a flow direction through the air filter housing (from the first end 3426 to the second end 3428). Each tapered edge of the flow element 3424 extends at an angle of inclination relative to a corner edge of the flow element 3424. In the embodiment of FIG. 84, a first angle of inclination of the first tapered edge is approximately equal to a second angle of inclination of the second tapered edge. In other embodiments, the first angle of inclination may be different from the second angle of inclination.

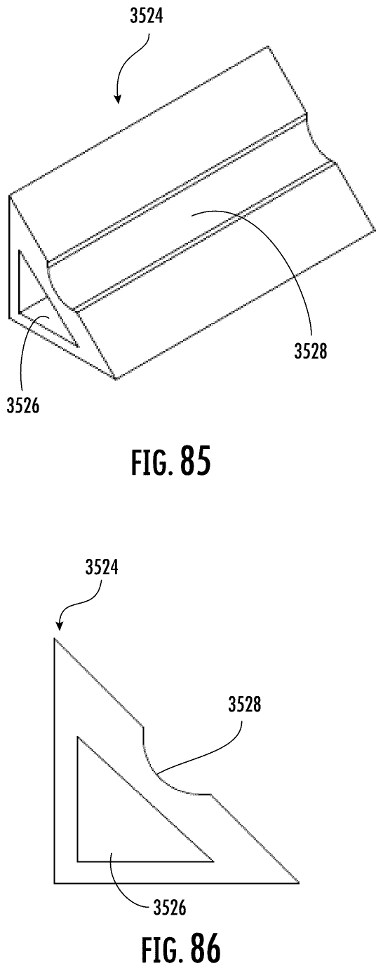

It should be appreciated that the size and shape of the flow element can be different in various embodiments. For example, FIGS. 85-86 show another example embodiment of a flow element 3524 for an air filter assembly. The flow element 3524 includes a hollow portion defining a channel 3526 therethrough. The flow element 3524 has an approximate uniform cross-sectional shape between opposing ends of the flow element 3524. In some embodiments, the flow element 3524 includes surface features, which can further improve flow performance and/or reduce weight of the flow element 3524. For example, as shown in FIGS. 85-86, the flow element 3524 an outer surface of the flow element 3524 (e.g., a flow facing surface, etc.) defines a rounded groove 3528 that extends in a longitudinal direction between opposing ends of the flow element 3524.

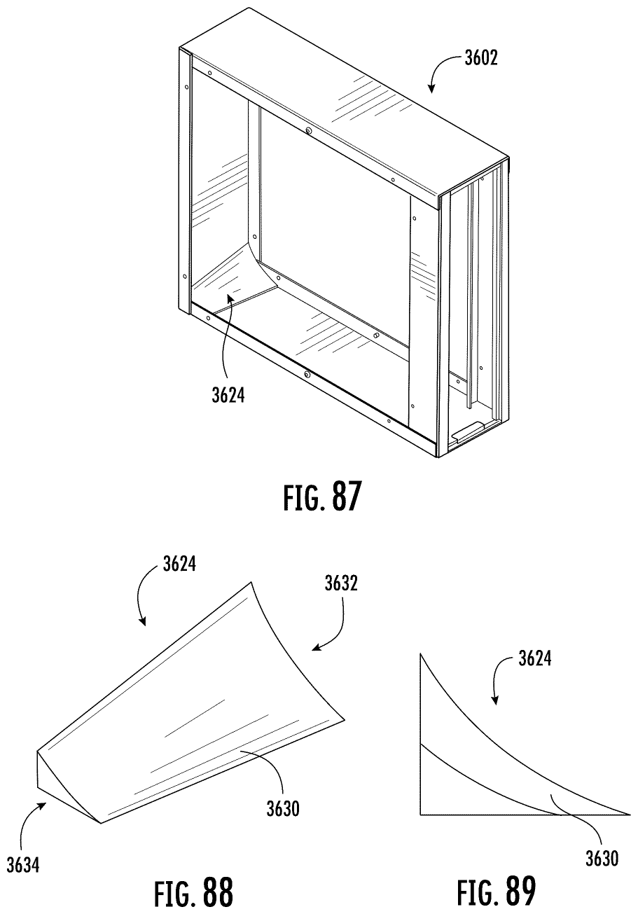

FIG. 87 shows another example embodiment of an air filter housing 3602 that includes a flow element 3624. Referring to FIGS. 88-89, and like the flow element of FIGS. 83-84, the flow element 3624 includes two tapered edges extending between opposing longitudinal ends of the flow element 3624. Additionally, the flow element 3624 defines an arcuate outer surface 3630. In some embodiments, the arcuate outer surface 3630 may have an approximately constant radius of curvature between opposing ends of the flow element 3624. In the embodiment of FIGS. 87-89, a radius of curvature of the upper surface increases toward the tapered end of the flow element 3624, from a first longitudinal end 3632 of the flow element 3624 to a second longitudinal end 3634 of the flow element 3624.

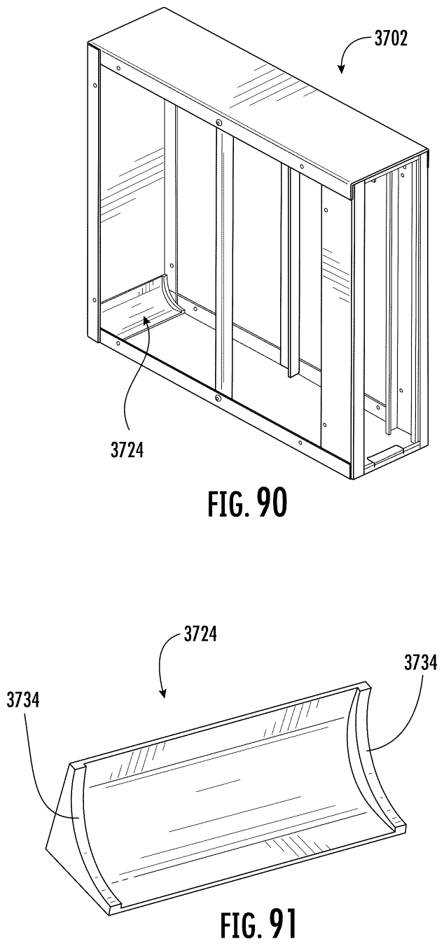

FIG. 90 shows yet another example embodiment of an air filter housing 3702 that includes a flow element 3724. Referring to FIG. 91, the flow element 3724 defines a curved outer surface having an approximately constant radius of curvature between opposing ends of the flow element 3724. The flow element 3724 also includes a lip 3734 (e.g., a protrusion, etc.) at each longitudinal end of the flow element 3724, which can reduce flow recirculation within a corner region proximate to an outer perimeter of one or more duct openings of the air filter housing 3702.

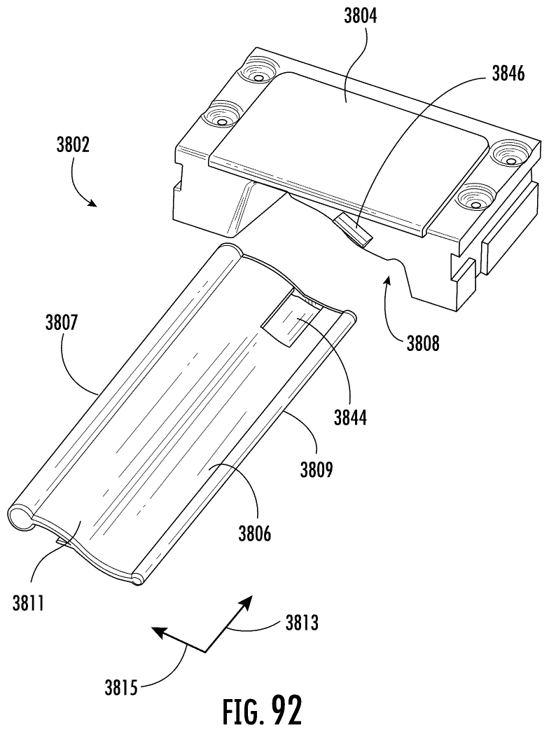

Referring to FIG. 92, a rail system 3802 of an air filter assembly is shown that includes (i) a magnetic material to facilitate engagement and alignment between a frame element, shown as a support element 3806, and (ii) a rail guide 3804. The support element 3806 is configured to slidably engage the rail guide 3804, which is configured to facilitate installation of the support element 3806 into a housing rail. The support element 3806 and the housing rail together are configured to support a filter media pack in an expanded position within the filter housing.

In the embodiment of FIG. 92, the support element 3806 includes a pair of interface members, shown as a first interface member 3807 and a second interface member 3809, and a connecting member 3811.

The interface members (e.g., interface elements, interface bodies, etc.) are configured to facilitate handling of the filter element and installation of (e.g., alignment between, etc.) the filter element into the filter housing. The first interface member 3807 and the second interface member 3809 are engageable with complementary receiving structures of the housing rail to support the support element 3806 on the housing rail. In some embodiments, the first interface member 3807 defines a first support ledge configured to engage a housing rail to support the first interface member 3807 on the housing rail, and the second interface member defines a second support ledge configured to engage a housing rail to support the second interface member 3809 on the housing rail.

Referring to FIG. 92, the first interface member 3807 extends along a longitudinal direction 3813 (e.g., an insertion direction, etc.) from a first longitudinal end of the support element 3806 to a second longitudinal end of the support element 3806 opposite from the first longitudinal end. The first interface member 3807 defines a first lateral end (e.g., a first lateral edge, etc.) of the support element 3806 along a lateral direction 3815 that is substantially perpendicular to the longitudinal direction 3813. In at least one embodiment, the first interface member 3807 extends along an entire length of the support element 3806, from the first longitudinal end of the support element 3806 to the second longitudinal end of the support element 3806.

The second interface member 3809 is spaced laterally apart from the first interface member 3807 and extends parallel to the first interface member 3807. The second interface member 3809 defines a second lateral end (e.g., a second lateral edge, a free end, a free edge, etc.) of the support element 3806 that is opposite the first lateral end. In at least one embodiment, the second interface member 3809 extends along an entire length of the support element 3806, from the first longitudinal end of the support element 3806 to the second longitudinal end of the support element 3806.

As used herein, “interface member” refers to a broad class of structures that are engageable with the housing rail to support the support element 3806 at least partially within the housing rail. In some embodiments, the interface members are protuberances that extend along opposing lateral ends of the support element 3806. For example, at least one interface member may include a rounded head or bulb extending along the first lateral end of the support element 3806. In other embodiments, the interface members may include slots, notches, indents, recessed areas, and/or channels extending along the lateral ends of the support element 3806. In yet other embodiments, the interface member includes an outer edge or ledge defined by the support element 3806 that is configured to engage the housing rail.

In some embodiments, at least one of the interface members includes at least a portion of a curved (e.g., a cylindrical, etc.) protrusion that extends along the lateral end. The curved protrusion may have a smooth/continuous curved side surface. In other embodiments, the interface members may include shapes that approximate a cylindrical protrusion such as an octagon having at least one planar side surface. In other embodiments, the interface member may include a differently shaped protrusion, protuberance, and/or prism, such as an elliptical protrusion having curved side surfaces, a triangular protrusion, a rectangular protrusion, or another polygonal prism having curved or uncurved edges that extend along the longitudinal direction 3813. In still further embodiments, at least one of the interface members includes multiple protrusions that are contiguous with one another (e.g., two cylindrical protrusions that are stacked together, etc.).

The connecting member 3811 extends substantially laterally away from the first interface member 3807 to the second interface member 3809. The connecting member 3811 is configured to engage and couple the filter media pack to the support element 3806. In some embodiments, the connecting member including an undulating wall that extends between the first interface member 3807 and the second interface member 3809, which can improve flow performance of the air filter assembly. In at least one embodiment, the support element 3806 (e.g., the connecting member 3811, the first interface member 3807, and/or the second interface member 3809) are integrally formed as a unitary body from a single piece of material, such as a non-magnetic and/or plastic material (e.g., nylon, glass-filed nylon, polypropylene, etc.). In some embodiments, the support element 3806 has the same or a similar structure as any of the support members described in U.S. patent application Ser. No. 18/499,042, filed Oct. 31, 2023, and/or U.S. patent application Ser. No. 18/664,128, filed May 14, 2024, the entire disclosures of which are hereby incorporated by reference herein.

In some embodiments, as described above, the support element 3806 is an endplate (e.g., endplate, frame member, frame element, etc.) of a filter element for an HVAC system. In other embodiments, the support element 3806 is an adapter that is configured to couple an endplate of a filter element to a housing rail (e.g., to engage an endplate on a first side of the support element 3806 and to engage the housing rail on a second side of the support element, etc.). The filter element (e.g., the support element 3806) includes a first magnetic material 3844 that is disposed on (e.g., coupled to, etc.) the support element 3806 (e.g., the connecting member 3811, etc.). The first magnetic material 3844 may include or be formed from a different material than the support element 3806. For example, the first magnetic material 3844 may be a permanent magnet or another ferrous material (e.g., iron, etc.) that is configured to magnetically interact with a second magnetic material 3846 that is coupled to the rail guide 3804.

The first magnetic material 3844 is coupled to the support element 3806 (e.g., the connecting member 3811, the first interface member 3807, and/or the second interface member 3809, etc.) at or adjacent to a first longitudinal end of the support element 3806 and extends in the longitudinal direction from the first longitudinal end toward a second longitudinal end. The first magnetic material 3844 is disposed at a central position (e.g., a central point, etc.) along the first longitudinal end of the support element 3806 (e.g., a central position/point between opposing lateral ends of the support element 3806, etc.). In the embodiment of FIG. 92, the first magnetic material 3844 is disposed over a portion of the connecting member 3811 that is spaced apart (e.g., in a substantially lateral direction) from both the first interface member 3807 and the second interface member 3809. Such an arrangement can facilitate centering of the support element 3806 with respect to the rail guide 3804 during installation of the filter element, and reduce off-center forces that could make installation more difficult. Additionally, such an arrangement can reduce the complexity of the support element 3806 by eliminating the need for complex fasteners to secure the first magnetic material 3844 to other portions of the support element 3806.

In some embodiments, as shown in FIG. 92, the first magnetic material 3844 (e.g., a first magnet, a first magnetic element, etc.) is disposed within a recessed area of the support element 3806 that extends in the longitudinal direction from the first longitudinal end of the support element 3806. The first magnetic material 3844 may include a magnet element having an elongated body that extends in the longitudinal direction 3813, which can increase the duration of the installation operation over which the magnetic material facilitates alignment with the rail guide 3904. The magnet element may be made from a ferromagnetic material or may be a permanent magnet. In some embodiments, the first magnetic material 3844 is bonded (e.g., adhered, etc.) to the support element 3806 using an adhesive material (e.g., glue, etc.). In other embodiments, the first magnetic material 3844 is coupled to the support element 3806 using a mechanical fastener (e.g., a clip, a bolt, etc.). For example, the first magnetic material 3844 may include a spring-loaded clip that is pressed onto the support element 3806. In other embodiments, the first magnetic material 3844 is impregnated or otherwise embedded within the material of the support element 3806.

The rail guide 3804 includes a second magnetic material 3846 (e.g., a second magnet, a second magnetic element, etc.) that is coupled to the rail guide 3804 adjacent to the access opening of the filter housing. Similar to the first magnetic material 3844, the second magnetic material 3846 may be a permanent magnet or another ferrous material (e.g., iron, etc.) that is configured to magnetically interact with a first magnetic material 3844. In the embodiment of FIG. 92, the second magnetic material 3846 is disposed at a central location along a perimeter of a funnel opening 3808 defined by the rail guide 3804. The second magnetic material 3846 extends in the longitudinal direction away from the access opening. In some embodiments, the second magnetic material 3846 is disposed within a recessed area along the outer perimeter of the funnel opening 3808. In other embodiments, the second magnetic material 3846 is coupled to the rail guide 3804 using a mechanical fastener (e.g., a clip, a bolt, etc.). In other embodiments, the second magnetic material 3846 is impregnated or otherwise embedded within the material of the rail guide 3804.

During installation, the first magnetic material 3844 is drawn toward the second magnetic material 3846, which facilitates centering of the support element 3806 with respect to the rail guide 3804 and reduces the force required from a user during installation to maintain the filter element in an expanded position. In some embodiments, the filter element further includes a second support element that is substantially similar to (e.g., identical to) the support element 3806 and that also includes a magnetic material. Such a combination can significantly reduce complexity of installation by reducing the holding force required to support the filter element in an expanded position during installation. The magnetic coupling between the support element 3806 and the rail guide 3804 also draws the support element 3806 into the funnel opening 3808 thereby reducing the force required to insert the filter element. In some embodiments, due to its location adjacent the access opening, the second magnetic material 3846 may be used to at least partially secure a cover to the filter housing, and to facilitate alignment of the cover with the access opening. For example, the second magnetic material 3846 may be configured to engage a third magnetic material on the cover to magnetically couple the cover to the filter housing.

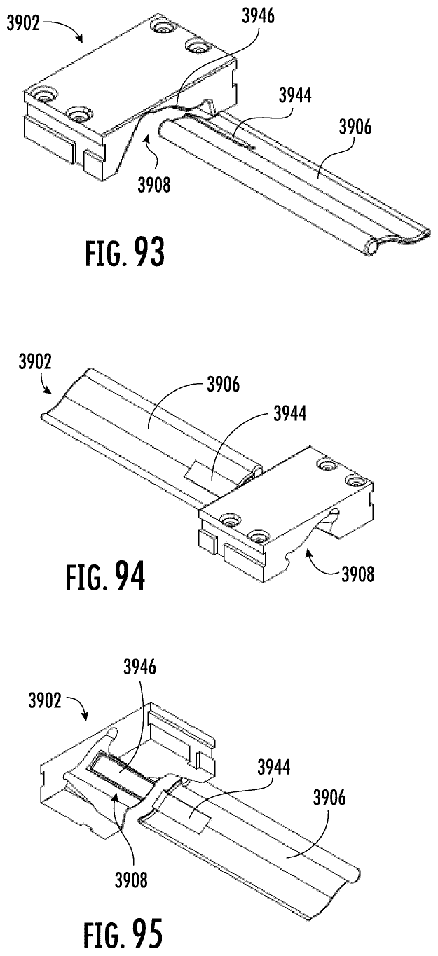

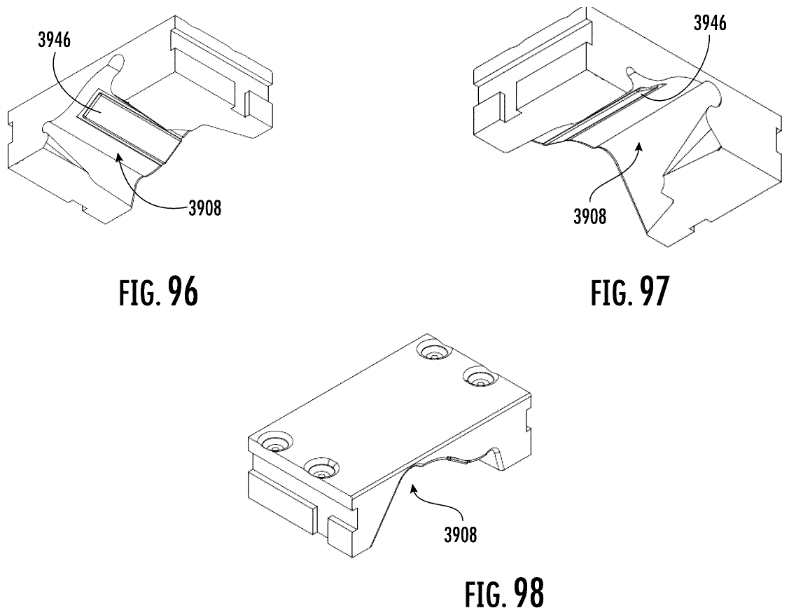

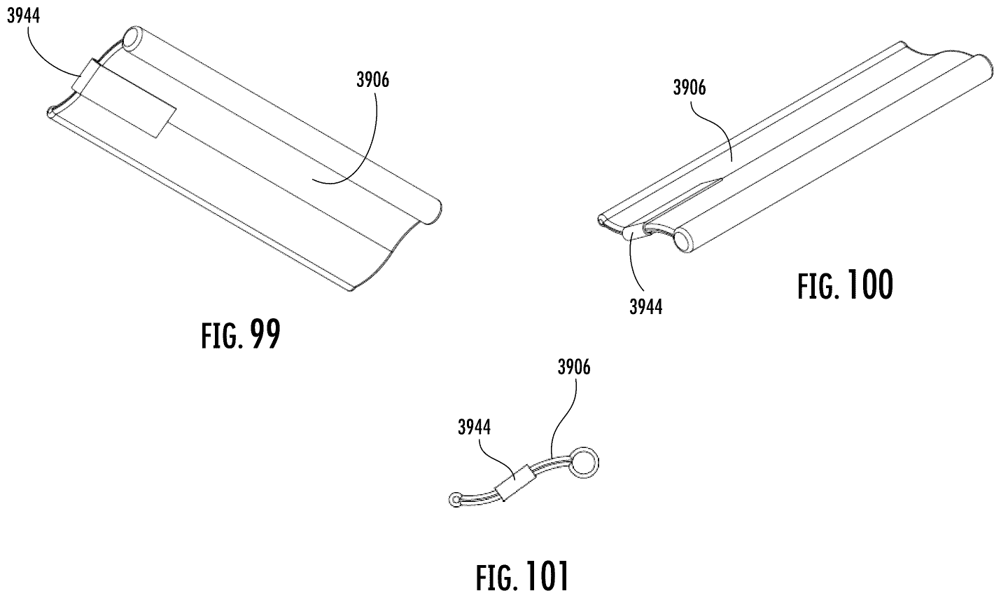

The number and arrangement of the first magnetic material and the second magnetic material may be different in various embodiments. For example, referring to FIGS. 93-101, a rail system 3902 is shown in which a first magnetic material 3944 of the support element 3906 is formed as a clip that is pressed (e.g., clipped, hooked, etc.) onto and/or over a portion of the first longitudinal end of the support element 3906 during manufacturing operations. In some embodiments, the support element 3906 includes a groove, a recessed area, or ribs (e.g., extension elements, etc.) defining a land area in which the first magnetic material 3944 is received. The first magnetic material 3944 may be disposed over the land area and may cover the land area in some embodiments.

Referring still to FIGS. 93-101, a second magnetic material 3946 is disposed within a recessed area along a perimeter of the funnel opening 3908 and defines at least a portion of the outer perimeter. The second magnetic material 3946 extends along the longitudinal direction, which can reduce the insertion force required to push the support element 3906 into the funnel opening 3908.

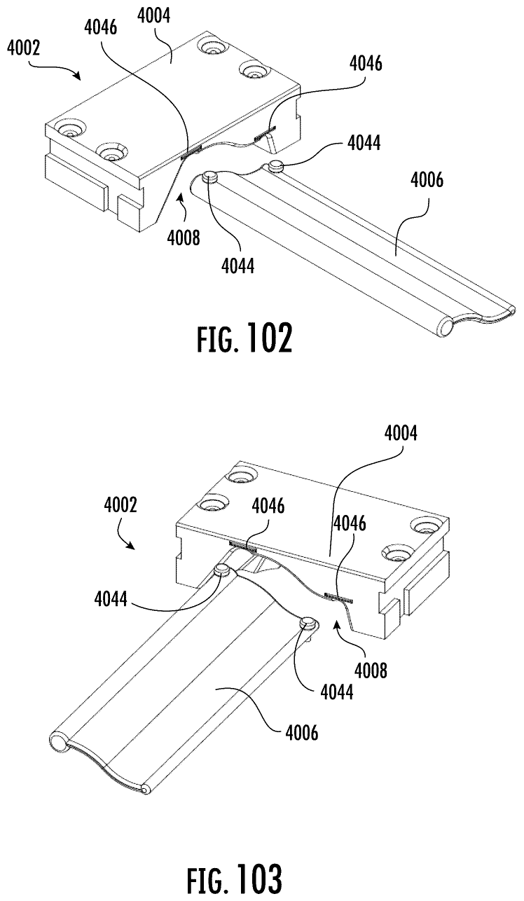

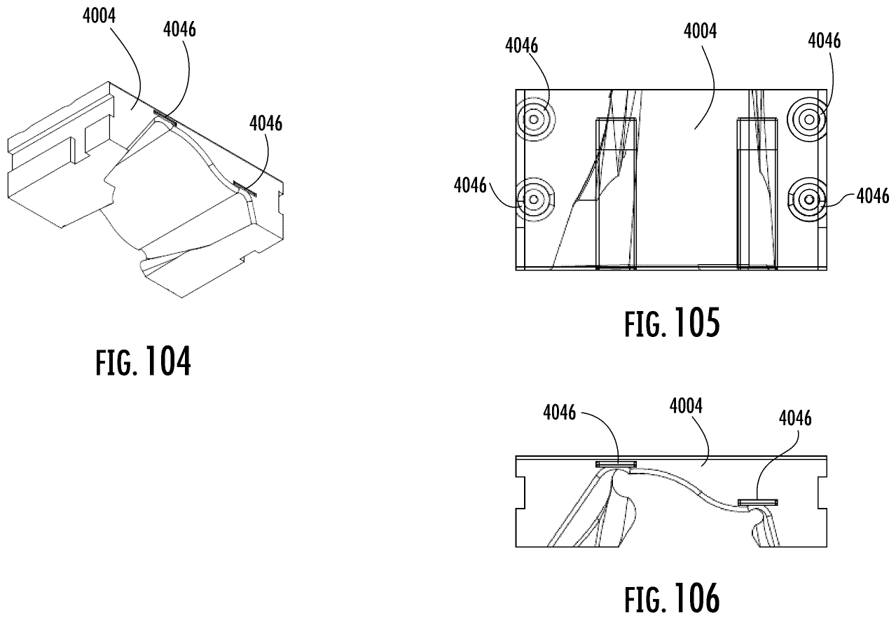

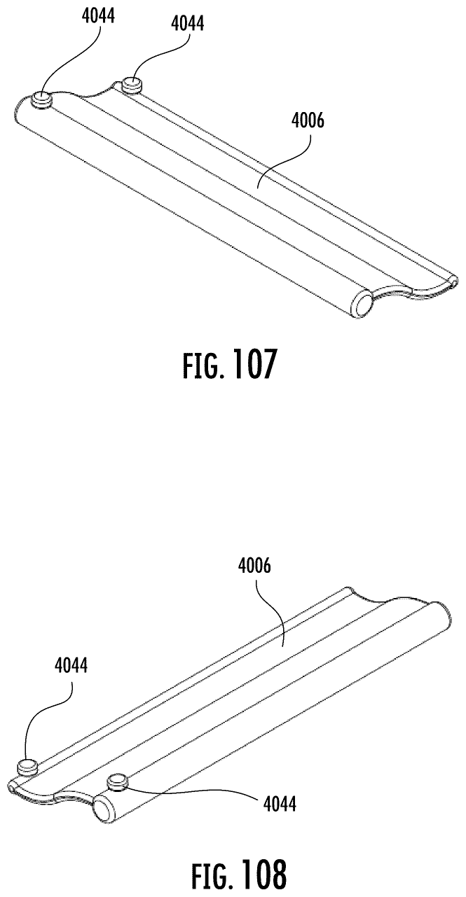

The number of magnetic elements used to facilitate coupling between the support element and rail guide may also differ in other embodiments. For example, in FIGS. 102-108, a rail system 4002 for an air filter assembly is shown that includes a plurality of first magnetic elements 4044 and a plurality of second magnetic elements 4046. The plurality of first magnetic elements 4044 includes a pair of first magnetic elements 4044 disposed adjacent to a first longitudinal end of the support element 4006. In some embodiments, each magnetic element of the pair of magnetic elements 4044 is disposed adjacent to a respect one of the lateral ends of the support element 4006. For example, each magnetic element may be disposed on a respective one of a pair of interface members that define lateral ends of the support element 4006 (e.g., a first interface element and a second interface element). Among other benefits, locating the magnetic elements at the lateral ends of the support member can improve stability during installation and reduce the risk of turning or tilting the element out of alignment with the rail guide.

The plurality of second magnetic elements 4046 are coupled to a rail guide 4004 at a location along the perimeter of a funnel opening 4008 that is adjacent to where the interface members engage the funnel opening 4008. In the embodiment of FIGS. 102-108, the plurality of first magnetic elements 4044 and the plurality of second magnetic elements 4046 are formed in the shape of small disks. In other embodiments, the shape of the magnetic elements may differ.

As used herein, the terms “approximately,” “about,” “substantially,” and similar terms are intended to have a broad meaning in harmony with the common and accepted usage by those of ordinary skill in the art to which this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial modifications or alterations of the subject matter described and claimed are considered to be within the scope of the application as recited in the appended claims.

The terms “coupled,” “connected,” and the like, as used herein, mean the joining of two members directly or indirectly to one another. Such joining may be stationary (e.g., permanent) or movable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the apparatus and control system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments.

Other substitutions, modifications, changes and omissions may also be made in the design, operating conditions and arrangement of the various exemplary embodiments without departing from the scope of the present application. For example, any element disclosed in one embodiment may be incorporated or utilized with any other embodiment disclosed herein.

What is claimed is:

1. A filter element for a heating, ventilation, and/or air conditioning (HVAC) system, the filter element comprising:
a filter media pack;
a support element configured to couple the filter media pack to a filter housing, the support element extending along a longitudinal direction from a first longitudinal end to a second longitudinal end; and
a magnetic material disposed on the first longitudinal end of the support element, the magnetic material configured to magnetically engage a second magnetic material of the filter housing to facilitate alignment between a housing rail of the filter housing and the support element during installation of the support element into the filter housing.

2. The filter element of claim 1, wherein the magnetic material includes a magnet element having an elongated body that extends in the longitudinal direction from the first longitudinal end toward the second longitudinal end.

3. The filter element of claim 1, wherein the support element defines a recessed area at the first longitudinal end thereof, wherein the magnetic material is disposed over at least a portion of the recessed area.

4. The filter element of claim 1, wherein the magnetic material is embedded within the support element.

5. The filter element of claim 1, wherein the magnetic material is a clip that is pressed over a portion of the first longitudinal end of the support element.

6. The filter element of claim 1, wherein the magnetic material includes a pair of magnetic elements, each magnetic element of the pair of magnetic elements disposed adjacent to a respective one of a first lateral end of the support element and a second lateral end of the support element opposite the first lateral end.

7. The filter element of claim 1, wherein the support element includes:
a connecting member configured to couple the support element to the filter media pack;
a first interface member disposed at a first lateral end of the connecting member; and
a second interface member disposed at a second lateral end of the connecting member, wherein the magnetic material is disposed over a portion of the connecting member that is spaced apart from both the first interface member and the second interface member.

8. The filter element of claim 1, further comprising a second support element coupled to an opposing end of the filter media pack as the support element, wherein the filter media pack is reconfigurable between a collapsed position in which the support element and the second support element are separated by a first distance, and an expanded position in which the support element and the second support element are separated by a second distance that is greater than the first distance.

9. The filter element of claim 1, wherein the support element is formed from a non-magnetic material, and wherein the magnetic material includes one of a ferromagnetic material or a permanent magnet.

10. A support element for a filter element for a heating, ventilation, and/or air conditioning (HVAC) system, the support element comprising:
a first interface member extending along a longitudinal direction;
a second interface member spaced apart from the first interface member and extending parallel to the first interface member;
a connecting member configured to couple the first interface member and the second interface member to a filter media pack, the connecting member extending from the first interface member to the second interface member; and
a magnetic material disposed on a first longitudinal end of at least one of the connecting member, the first interface member, or the second interface member.

11. The support element of claim 10, wherein the magnetic material includes magnet element having an elongated body that extends in the longitudinal direction from the first longitudinal end toward a second longitudinal end of the at least one of the connecting member, the first interface member, or the second interface member that is opposite from the first longitudinal end.

12. The filter element of claim 10, wherein the connecting member defines a recessed area at the first longitudinal end thereof, and wherein the magnetic material is disposed over at least a portion of the recessed area.

13. The filter element of claim 10, wherein the magnetic material is embedded within the at least one of the connecting member, the first interface member, or the second interface member.

14. The filter element of claim 10, wherein the magnetic material is a clip that is pressed over a portion of the first longitudinal end.

15. The filter element of claim 10, wherein the magnetic material includes a pair of magnetic elements, each magnetic element of the pair of magnetic elements disposed on a respective one of the first interface member and the second interface member.

16. The filter element of claim 10, wherein the connecting member, the first interface member, and the second interface member are integrally formed from a non-magnetic material, and wherein the magnetic material includes one of a ferromagnetic material or a permanent magnet.

17. A filter element for a heating, ventilation, and/or air conditioning (HVAC) system, the filter element comprising:
a filter media pack;
a first support element coupled to the filter media pack; and
a second support element coupled to an opposing end of the filter media pack as the first support element, wherein the filter media pack is reconfigurable between a collapsed position in which the first support element and the second support element are separated by a first distance along an expansion direction of the filter media pack, and an expanded position in which the first support element and the second support element are separated by a second distance along the expansion direction that is greater than the first distance, wherein the first support element includes a snap-fit interface that is configured to couple the first support element to a housing rail.

18. The filter element of claim 17, wherein the snap-fit interface is configured to couple the first support element to the housing rail along a first direction and to slidably engage the first support element to the housing rail along a second direction that is substantially perpendicular to the first direction.

19. The filter element of claim 17, wherein the snap-fit interface includes a first clip member and a second clip member arranged parallel to and offset from the first clip member, the first clip member and the second clip member together defining a channel.

20. The filter element of claim 17, wherein the snap-fit interface is configured to couple the first support element to the housing rail by pressing the first support element against the housing rail along the expansion direction of the filter media pack.
